(19) United States
(12) Patent Application Publication
(10) Pub. No.: US 2021/0099874 A1
(43) Pub. Date: Apr. 1, 2021

(54) METHOD AND SYSTEM FOR AVOIDANCE OF USER RE-REGISTRATION

(71) Applicant: Konica Minolta Business Solutions U.S.A., Inc., Ramsey, NJ (US)

(72) Inventor: Rahul Suraparaju, Fremont, CA (US)

(73) Assignee: Konica Minolta Business Solutions U.S.A., Inc., Ramsey, NJ (US)

(21) Appl. No.: 16/588,803

(22) Filed: Sep. 30, 2019

(51) Int. Cl. H04W 12/06; H04L 9/32; H04L 29/06; H04L 9/08; H04W 12/04; H04W 12/00; H04W 60/00

(52) U.S. Cl. CPC H04W 12/0609; H04L 9/3268; H04L 9/3271; H04L 9/3231; H04L 63/0823; H04L 63/083; H04L 67/42; H04W 12/0401; H04W 12/04071; H04W 12/001; H04W 60/00; H04L 2463/082; H04L 9/0844

(57) ABSTRACT

A method, a non-transitory computer readable medium, and a system are disclosed for avoidance of user re-registration. The method includes: registering a user and a biometric device on a computing device; sending a registration digital artifact for the user and the biometric device to an authentication server; registering a mobile device configured to support Public Key Infrastructure (PKI) as a roaming authenticator, the mobile device being registered or tied to information related to the user; and provisioning the user and the mobile device with roaming authentication, the roaming authentication being accessed through the mobile device and configured to provide the user and the mobile device access to computing devices in which the user and the mobile device have not previously been used for authentication.

### FIELD OF THE INVENTION

The present disclosure generally relates to methods and systems for one-time multiple registration chain with Public Key Infrastructure-credential (PKI-credential) anchoring and universal registration, avoidance of user re-registration, and universal roaming via captive authentication.

### BACKGROUND OF THE INVENTION

Single sign-on (SSO) is an authentication process that allows a user to access multiple applications with one set of login credentials. Single sign-on, for example, is a common procedure in enterprises, where a client accesses multiple resources connected to a local area network (LAN).

Variations of single sign-on authentication has been developed using mobile devices as access credentials. For example, mobile devices can be used to automatically log the user onto multiple systems, such as building-access-control systems and computer systems, through the use of authentication methods which include OpenID Connect and SAML, in conjunction, for example, with an X.509 ITU-T cryptography certificate used to identify the mobile device to an access server.

Currently, the biometric based client-server authentication systems has four flows, (1) a user registration flow, (2) a user authentication flow, (3) a user roaming authentication flow, and (4) a user de-register and/or revocation flow.

User registration process involves recording user's profile (for example, user credentials, etc.) and the associated biometric device address in the server, as the server performs user's credentials in a secure fashion. Typically, for example, username and password can be used for credential storing.

Such a process for recording a user's profile takes place in the eco-system that is hybrid in nature, because the authentication solution software integrates with the software components of various biometric-solution vendors. Software components of biometric-solutions interact with the user(s), while solution-specific software components fall into centralized system with scalable two-tier client server systems.

Due to involved hybrid-integration of bio-metric software components and solution-specific software components, currently every specific solution requires its own specific client software components to software-integrate tightly with bio-metric software components. Therefore, this current way of achieving user registration process results in every authentication solution vendor to design and develop the client software components to interoperate with biometric software components on the computing devices where their users perform user registration.

### SUMMARY OF THE INVENTION

In consideration of the above issues, it would be desirable to achieve a client-less system in the user registration process, so that all solution-specific vendors will be completely relieved of writing their client software components. In accordance with an exemplary embodiment, the client-less system can achieve benefits that can include computing devices that act as registration station now requires only biometric software components installed and run and therefore much efficient with respect to central processing unit (CPU) and memory utilizations, and the registration process becomes uniform across all solution vendors for any given bio-metric solution.

In addition, it would be desirable to have a method and system for new user registration and authentication procedures to achieve avoidance of user re-registration on a pristine computing device (i.e., original computing device). In accordance with an exemplary embodiment, a pristine computing device can be any client or computing device in which the user and corresponding device tied to the user has not been authenticated via, for example, a mobile device.

Furthermore, it would be desirable to have a method and system, which applies to comprehensive network security systems offering secure authentication and service authorizations solutions for the enterprise users, and which helps solve the traditional problems faced by current industry.

A method is disclosed for client-less user registration of biometric devices for client-server authentication systems, the method comprising: embedding a registration URL address of a solution provider server on a computing device; hosting a generic registration proxy dispatcher service and a solution specific registration handler on the solution provider server, the generic registration proxy dispatcher configured to interact directly or indirectly with a biometric software application on the computing device, and wherein the solution specific registration handler is configured to handle one or more vendors of services; directing a registration of a user and a biometric device to the solution provider server via a browser on the computing device using the registration URL address; and registering the user and the biometric device in a vendor database.

A non-transitory computer readable medium storing computer readable program code executed by a processor for a process for client-less user registration of biometric devices for client-server authentication systems is disclosed, the process comprising: embedding a registration URL address of a solution provider server on a computing device; hosting a generic registration proxy dispatcher and a solution specific registration handler on the solution provider server, the generic registration proxy dispatcher configured to interact directly or indirectly with a biometric software application on the computing device, and wherein the solution specific registration handler configured to handle one or more vendors of services; directing a registration of a user and a biometric device to the solution provider server via a browser on the computing device using the registration URL address; and registering the user and the biometric device in a vendor database.

A system is disclosed for client-less user registration of biometric devices for client-server authentication systems, the system comprising: a solution provider server having a processor configured to: host a generic registration proxy dispatcher service and a solution specific registration handler on the solution provider server, the generic registration proxy dispatcher configured to interact directly or indirectly with a biometric software application on the computing device, and wherein the solution specific registration handler configured to handle one or more vendors of services; direct a registration of a user and a biometric device to the solution provider server via a browser on the computing device using a registration URL address; and register the user and the biometric device in a vendor database.

A method is disclosed for avoidance of user re-registration, the method comprising: registering a user and a biometric device on a computing device; sending a registration digital artifact for the user and the biometric device to an authentication server; registering a mobile device configured to support Public Key Infrastructure (PKI) as a roaming authenticator, the mobile device being registered or tied to information related to the user; and provisioning the user and the mobile device with roaming authentication, the roaming authentication being accessed through the mobile device and configured to provide the user and the mobile device access to computing devices in which the user and the mobile device have not previously been used for authentication.

A non-transitory computer readable medium storing computer readable program code executed by a processor for a process for avoidance of user re-registration is discloses, the process comprising: registering a user and a biometric device on a computing device; sending a registration digital artifact for the user and the biometric device to an authentication server; registering a mobile device configured to support Public Key Infrastructure (PKI) as a roaming authenticator, the mobile device being registered or tied to information related to the user; and provisioning the user and the mobile device with roaming authentication, the roaming authentication being accessed through the mobile device and configured to provide the user and the mobile device access to computing devices in which the user and the mobile device have not previously been used for authentication.

A system is disclosed for avoidance of user re-registration, the system comprising: an authentication server having a processor configured to: register a user and a biometric device; registering a mobile device configured to support Public Key Infrastructure (PKI) as a roaming authenticator, the mobile device being registered or tied to information related to the user; and provision the user and the mobile device with roaming authentication, the roaming authentication being accessed through the mobile device and configured to provide the user and the mobile device access to computing devices in which the user and the mobile device have not previously been used for authentication.

A method is disclosed for universal roaming via captive authentication, the method comprising: registering a user on a client device; sending a registration digital artifact for the user and the client device to an authentication server; provisioning the user with a registration request for captive roaming authentication service on the client device, the captive roaming authentication service configured to provide the user with access to additional computing devices; and registering the client device with the captive roaming authentication service on the authentication server with a roaming Public Key Infrastructure (PKI) credential, the PKI credential configured to provide the user with the access to the additional computing devices.

A method is disclosed of authenticating a user for services on a computing device, the method comprising; storing a roaming Public Key Infrastructure (PKI) credential in a secure container on a client device; hosting a captive roaming authentication protocol on the client device and the computing device in which the user has not been previously authenticated; authenticating the user on a computing device by placing the client device with roaming PKI credentials in proximity to the computing device to initiate a handshake between the client device and the computing device; unlocking the secure container using an authenticator to retrieve the roaming PKI credential; sending a signed assertion from the client device to the computing device with the roaming PKI credential; posting the signed assertion with the roaming PKI credential to the authenticating server; and receiving a response from the authenticating server that the roaming PKI credential of the client device has been verified.

A non-transitory computer readable medium storing computer readable program code executed by a processor for a process for universal roaming via captive authentication is disclosed, the process comprising: registering a user on a client device; sending a registration digital artifact for the user and the client device to an authentication server; provisioning the user with a registration request for captive roaming authentication service on the client device, the captive roaming authentication service configured to provide the user with access to additional computing devices; and registering the client device with the captive roaming authentication service on the authentication server with a roaming Public Key Infrastructure (PKI) credential, the PKI credential configured to provide the user with the access to the additional computing devices

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system for user registration and resource enforcement, for example, for multi-function printers accessed from a mobile client and/or a client with biometric based authentication in accordance with an exemplary embodiment.

FIG. 2 is an illustration of a computer or a server in accordance with an exemplary embodiment.

FIG. 3A is an illustration of a mobile device in accordance with an exemplary embodiment.

FIG. 3B is an illustration of a display unit or user interface of a mobile device in accordance with an exemplary embodiment.

FIG. 4 is an illustration of a biometric device for client authentication in accordance with an exemplary embodiment.

FIG. 5 is an illustration of a multi-function printer or printer in accordance with an exemplary embodiment.

FIG. 6 is an illustration of an example of a bio-metric user registration process for a user with authentication client software in accordance with a current user registration.

FIG. 7 is an illustration of a client-less registration system in accordance with an exemplary embodiment.

FIG. 8 is a flow chart illustrating a client-less registration process in accordance with an exemplary embodiment.

FIG. 9 is an illustration of a registration relationship between primary authenticators and a roaming authenticator stored in a server (database) in accordance with an exemplary embodiment.

FIG. 10 is an illustration of a system for user roaming authentication registration having a biometric device and a mobile client in accordance with an exemplary embodiment.

FIG. 11 is a flow chart showing a registration flow in accordance with an exemplary embodiment.

FIG. 12 is a flow chart showing a registration flow in accordance with another exemplary embodiment.

FIG. 13 is a flow chart showing a registration flow in accordance with an exemplary embodiment.

FIG. 14 is a flow chart showing a registration flow in accordance with another exemplary embodiment.

FIG. 15 is an illustration of a onetime multiple-registration chain with PKI-Credential Anchoring for a user (user ‘m’) in accordance with an exemplary embodiment.

FIG. 16 is an illustration of a system in which a user can experience universal flows roaming experience in accordance with an exemplary embodiment.

FIG. 17 is an illustration of a protocol format of a NFC protocol stack in accordance with an exemplary embodiment.

FIG. 18 is an illustration of a NFC message format, and wherein the NFC message contains multiple NFC records.

FIG. 19 is an illustration of a communication between NFC peers.

FIG. 20 is a table of the captive roaming authentication (CRA) protocol illustrating registration flows, roaming authentication and interoperability across different platforms and different authenticators.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

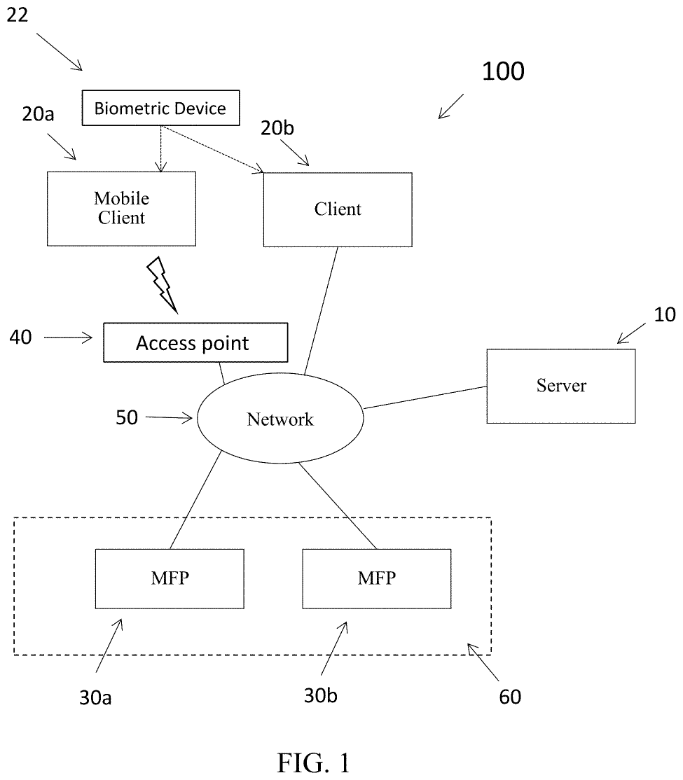

FIG. 1 is an illustration of a system 100 for user registration and resource enforcement, for example, for multi-function printers 30a, 30b accessed from a mobile client 20a and/or a client 20b in accordance with an exemplary embodiment. As shown in FIG. 1, the system 100 can include one or more enterprise servers 10, one or more mobile clients or mobile computers 20a, one or more clients or computers 20b, one or more biometric devices 22, and optionally one or more multi-function printers or image forming apparatuses 30a, 30b. In accordance with an exemplary embodiment, the one or more enterprise servers 10, the one or more mobile clients or mobile computers 20a, the one or more clients or computers 20b, and the optional one or more multi-function printers or image forming apparatuses 30a, 30b can be connected via a communication network 50. In accordance with an exemplary embodiment, the one or more multi-function printers or image forming apparatuses 30a, 30b, can be part of a local area network (LAN) 60, and managed, for example, by the one or more enterprise servers 10.

In accordance with an exemplary embodiment, the communication network or network 50 can be a public telecommunication line and/or a network (for example, LAN or WAN). Examples of the communication network 50 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF) and/or infrared (IR) transmission.

In addition, for example, an access point 40 can communicate with the communication network 50 to provide wireless or cellular data communication between the mobile computer (for example, a smart phone) 20a, and the communication network 50. In accordance with an exemplary embodiment, the access point 40 can be any networking hardware device that allows a Wi-Fi device to connect to a wired network, or a hardware device that can allow a cellular device, for example, the mobile computer (or smartphone) 20a to connect to the wired network 50.

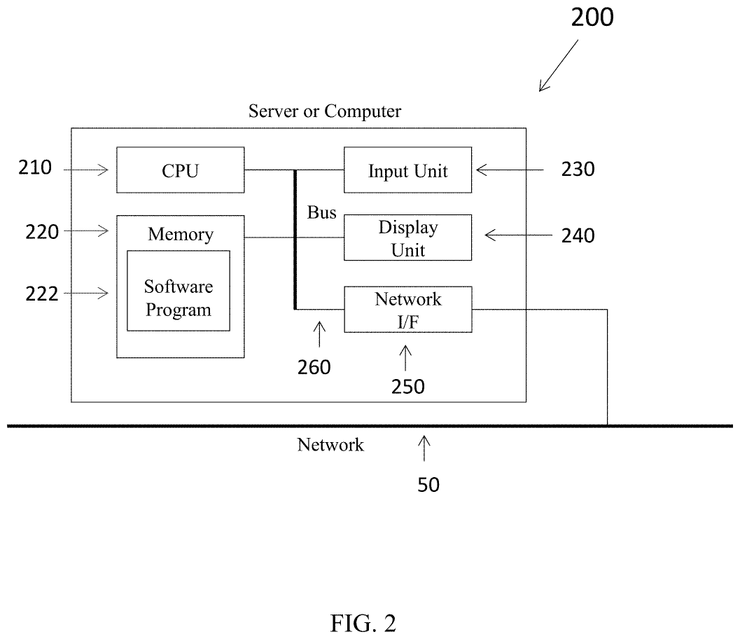

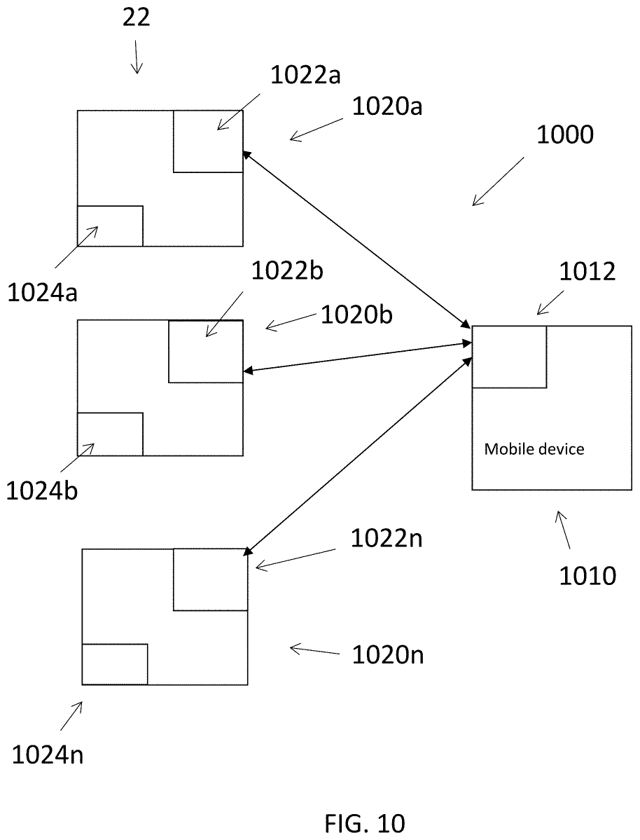

FIG. 2 is an illustration of a computing device 200, which can be a server 10, or a client device 20, or computer 20b, computing device 1102 (FIG. 11). As shown in FIG. 2, the exemplary computing device 200 can include a processor or central processing unit (CPU) 210, and one or more memories 220 for storing software programs and data 222. The processor or CPU 210 carries out the instructions of a computer program, which operates and/or controls at least a portion of the functionality of the computing device 200. The computing device 200 can also include an input unit 230, a display unit or graphical user interface (GUI) 240, and a network interface (I/F) 250, which is connected to a communication network (or network) 50. A bus 260 can connect the various components 210, 220, 230, 240, 250 within the computing device 10a, 10b, 10c, 20b.

In accordance with an exemplary embodiment, the computing device 200 can include a display unit or graphical user interface (GUI) 240, which can access, for example, a web browser (not shown) in the memory 220 of the computing device 200. The computing device 200 also includes an operating system (OS), which manages the computer hardware and provides common services for efficient execution of various software programs. In accordance with an exemplary embodiment, the OS of the CPU 210 is a Linux, Windows®, or Macintosh (Mac) based operating system. The software programs can include, for example, application software and printer driver software. For example, the printer driver software controls a multi-function printer or printer (not shown), for example connected with the computing device 200 in which the printer driver software is installed via the communication network 50. In certain embodiments, the printer driver software can produce a print job and/or document based on an image and/or document data.

In accordance with an embodiment, the computing device 200 can be an enterprise server 10, which can include a mobile device management (MDM) component configured to administer mobile client or mobile client devices 20 a, for example, smartphones, tablet computer, laptops, and desktop computers. For example, the MDM component can be a combination of on-device applications and configurations, corporate policies and certificates, and backend infrastructure, for the purpose of simplifying and enhancing the information technology (IT) management of end user devices, for example, mobile clients 20a. In accordance with an exemplary embodiment, the MDM component can be designed to increase supportability, security, and corporate functionality of mobile clients 20a while maintaining some user flexibility.

In accordance with an exemplary embodiment, the MDM component can be configured to administer devices and applications using mobile device management products and services, which can include corporate data segregation, securing emails, securing corporate documents on devices, enforcing corporate policies, integrating and managing mobile devices including laptops and handhelds of various categories. In accordance with an exemplary, the mobile device management implementations may be either on-premises or cloud-based. For example, the MDM component can be configured to ensure that diverse user equipment is configured to a consistent standard/supported set of applications, functions, or corporate policies; update equipment, applications, functions, or policies in a scalable manner; ensure that users use applications in a consistent and supportable manner, ensure that equipment performs consistently, monitor and track equipment (e.g. location, status, ownership, activity), and efficiently diagnose and troubleshoot equipment remotely. For example, in accordance with an exemplary embodiment, the MDM component can be configured to handle distribution of applications, data and configuration settings for all types of mobile devices, including mobile phones, smartphones, tablet computers, mobile computers, and mobile printers.

In accordance with an exemplary embodiment, the computing device 200 in the form of the enterprise server 10 can include a document management and storage system. In accordance with an exemplary embodiment, the document management and storage system can be configured to handle enterprise content and document management, for example, for storage, retrieval, searching, archiving, tracking, management, and reporting on electronic documents and records. In accordance with an exemplary embodiment, the SPS server can be used as intranet or intranet portal to centralize access to enterprise information and applications, collaborative software, file hosting, and custom web applications. For example, the SPS server can be configured to handle various application programming interfaces, for example, application programming interfaces, (APIs: client-side, server-side, JavaScript), REST, SOAP, and OData-based interfaces, and claims-based authentication, relying on, for example, SAML tokens for security assertions and/or an open authentication plugin model

In accordance with an exemplary embodiment, the SPS server can be configured to handle authentication of mobile clients or mobile devices 20a, for example, via a single sign-on (SSO) method. Single sign-on is an authentication process that allows a user to access multiple applications with one set of login credentials. Single sign-on, for example, is a common procedure in enterprises, where a user (or client) accesses multiple resources connected to a local area network (LAN) 60. For example, the single sign-on can be performed in connection with a biometric device 22, which authenticates a user, for example, by fingerprint recognition, electrocardiogram (ECG or EKG), iris detection, and or other authentication protocols, which are currently implemented or will be implemented on mobile devices. For example, a password authentication protocol, which uses credentials, such as username and password can be used in combination with biometric component, for example, ECG or EKG can be used.

In accordance with an exemplary embodiment, the SSO method can be Security Assertion Markup Language (SAML), which is an XML standard for exchanging single sign-on (SSO) information between an SAML Federation Identity Provider (SAML-IdP) who asserts the user identity and a SAML Federation Service Provider (SAML-SP) who consumes the user identity information. SAMLv2.0 (Security Assertion Markup Language version 2) supports IDP-initiated and SP-initiated flows. In IdP-initiated SAML SSO flow, the SAML-IdP creates a SAML single sign-on assertion for the user identity, and sends the SAML single sign-on assertion to the SP (Service Provider) in an unsolicited fashion. In SP-Initiated SAML SSO flow, the SP generates a SAML2.0 AuthnRequest (i.e., Authentication Request) that is sent to the SAML-IdP as the first step in the Federation process and the SAML-IdP then responds with a SAML Response, both of these interactions being asynchronous to each other.

In accordance with an exemplary embodiment, the SSO method can be OpenID Connect (OIDC), which is an identity layer on top of an OAuth 2.0 protocol, which allows computing clients to verify the identity of an end-user based on the authentication performed by an authorization server, as well as to obtain basic profile information about the end-user in an interoperable and REST-like manner. In technical terms, OpenID Connect specifies a RESTful (Representational State Transfer), HTTP (hypertext transfer protocol), and API (application program interface), using JSON (JavaScript Objection Notation) as a data format. OpenID Connect, for example, allows a range of clients, including Web-based, mobile, and JavaScript clients, to request and receive information about authenticated sessions and end-users. The specification suite can also support optional features such as encryption of identity data, discovery of OpenID Providers, and session management.

In accordance with an exemplary embodiment, the server 10 can be an enterprise server that includes a directory component, which is configured, for example, to host a database of users and/or resource parameters, which can be executed, for example, on the multi-function printer (MFP), imaging forming apparatus, the printer or the printing device 30a, 30b as disclosed herein. For example, the directory component can be an Active Directory (AD) server, or a lightweight directory access protocol (LDAP) server. In accordance with an exemplary embodiment, the managing of mobile clients 20a in enterprise systems is primarily performed, for example, by a MDM component 10a. However, as more workers have bought smartphone and tablet computing devices and have sought support for using these devices in the workplace, there are additional needs to control access to resources, for example, on devices, such as multi-function printers (MFPs) and image forming apparatuses 30a, 30b with a local area network (LAN). For example, enterprise software can include computer programs with common business applications, tools for modeling how the entire organization works, and development tools for building applications unique to the organization.

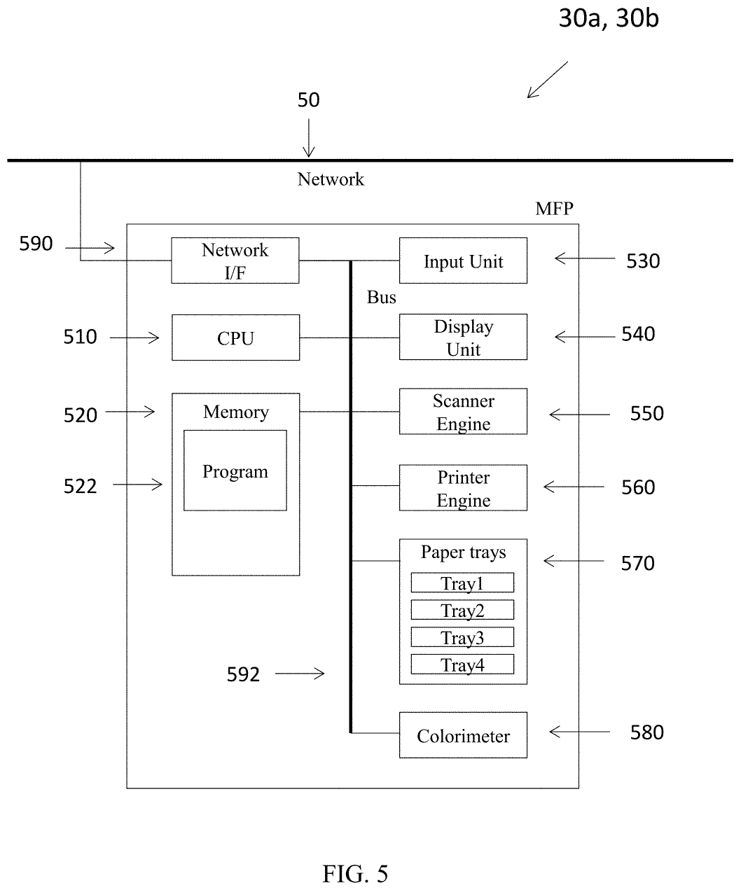

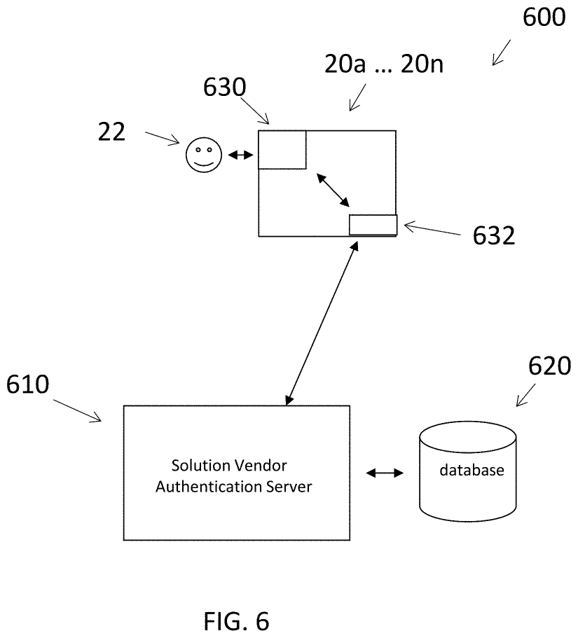

In accordance with an exemplary embodiment, the server 10 can be a solution vendor authentication server 610 (FIG. 6), a solution provider server (i.e., registration server) 710 (FIG. 7), a database (or database server) 620, 720 as disclosed herein.

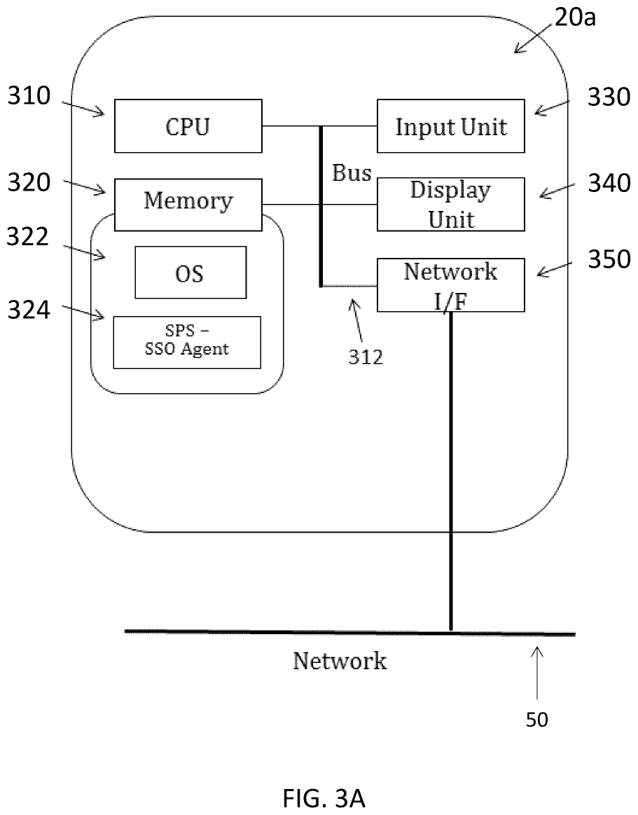

FIG. 3A is an illustration of a mobile client (or mobile device) 20a in accordance with an exemplary embodiment. As shown in FIG. 3A, the exemplary mobile client (or mobile device) 20a can include a processor or central processing unit (CPU) 310, and one or more memories 320 for storing software programs and data, an operating system 322, and an SPS-SSO agent 324. In accordance with an exemplary embodiment, the memory 320 includes the SPS-SSO agent 322, wherein the SPS-SSI agent 332 is configured to perform, for example, one or more the processes for enabling OIDC and SAML flows on a mobile application on the mobile device 300 via single sign-on (SSO) protocol. The processor or CPU 310 carries out the instructions of a computer program, which operates and/or controls at least a portion of the functionality of the mobile client (or mobile device) 20a. The mobile device 300 can also include an input unit 330, a display unit or graphical user interface (GUI) 340, and a network interface (I/F) 350, which is connected to a communication network (or network) 150. A bus 312 can connect the various components 310, 320, 330, 340, 350 within the mobile client (or mobile device) 20a.

In accordance with an exemplary embodiment, the mobile client (or mobile device) 20 a can include a display unit or graphical user interface (GUI) 340, which can access, for example, a web browser (not shown) in the memory 320 of the mobile client (or mobile device) 20a. The mobile client (or mobile device) 20a also includes the operating system (OS) 322, which manages the computer hardware and provides common services for efficient execution of various software programs. In accordance with an exemplary embodiment, the OS 322 of the mobile client (or mobile device) 20a is a Linux or Windows® based operating system. The software programs can include, for example, application software and printer driver software. For example, the printer driver software controls a multi-function printer or printer (not shown), for example connected with the mobile client (or mobile device) 20a in which the printer driver software is installed via the communication network 50. In certain embodiments, the printer driver software can produce a print job and/or document based on an image and/or document data

In accordance with an exemplary embodiment, the mobile client (or mobile device) 20a can also preferably include an authentication module, which authenticates a user, for example, by a single sign-on (SSO) method such as a biometric, for example, a fingerprint, palm veins, face recognition, DNA, palm print, hand geometry, iris recognition, electrocardiogram (ECG or EKG), and/or retina, or authentication, or other authentication protocol, which are currently implemented or will be implemented on mobile devices. For example, a password authentication protocol, which uses credentials, such as username and password can be used. In accordance with an exemplary embodiment, the SPS server 10b can include a single sign-on (SSO) service. In accordance with an exemplary embodiment, the authentication module can be for access to the mobile client (or mobile device 20a) and/or used in connection with a single sign-on (SSO) process as disclosed herein.

FIG. 3B is an illustration of a display unit or user interface (also known as a graphical user interface (GUI) 340 of a mobile client (or mobile device) 20a in accordance with an exemplary embodiment. As shown in FIG. 3B, the display unit or user interface 340 can be a touch screen (or touch pad) 342 having a plurality of icons 360, 362 for frequently used applications, for example, a print application, a telephone module, an e-mail client module, a browser module, a video and music player module, a messages module, a calendar, a camera module, maps, weather, and application or module, which provides access to settings for the mobile client (or mobile device) 20a and various applications.

In accordance with an exemplary embodiment, the mobile application (or software component) is an interface 360, 362 on the mobile client (or mobile device) 20a in which the user is authenticated before the user can avail (or access) any services from, for example, on premises software (for example, On Premises Legacy) and/or off premises software (for example, Cloud services). In accordance with an exemplary embodiment, the authentication of the user via a single sign-on (SSO) method (or protocol) can be done, for example, via biometrics, such as finger print, facial identification or facial recognition, iris detection, and/or username and PIN (personal identification number).

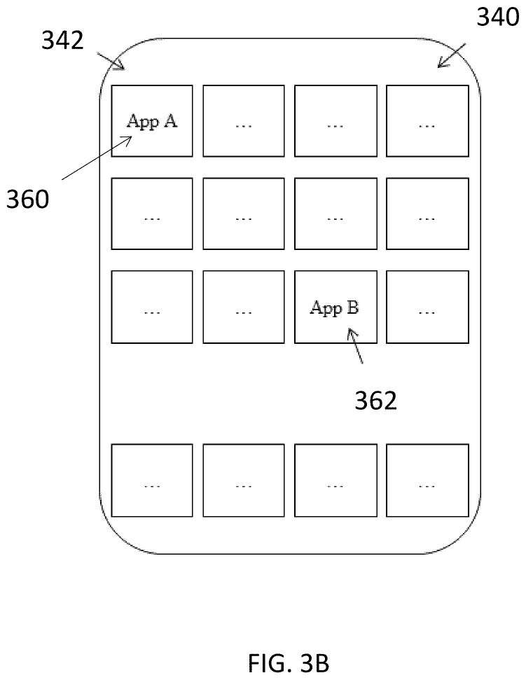

FIG. 4 is an illustration of a biometric device 22 for client authentication in accordance with an exemplary embodiment. In accordance with an exemplary embodiment, the exemplary biometric device 22 is a security identification and authentication device, which uses automated methods of verifying or recognizing the identity of a living person based on a physiological or behavioral characteristic. The method of recognizing the user can include, for example, fingerprints, electrocardiogram (ECG or EKG) information, facial images, iris, and voice recognition. For example, in accordance with an exemplary embodiment, the biometric device is a wearable device, for example, a Nymi™ band, which detection of the user is based on the electrocardiogram (ECG) and its unique properties, i.e., electrical activity of the heartbeat of the wearer.

As shown in FIG. 4, the biometric device 22 can include a processor or central processing unit (CPU) 410, and one or more memories 420 for storing software programs and data, for example, an operating system. In accordance with an exemplary embodiment, the processor or CPU 410 carries out the instructions of a computer program, which operates and/or controls at least a portion of the functionality of the biometric device 22. The biometric device 22 can also include an input unit and/or display unit or graphical user interface (GUI) 430, and a network interface (I/F) 440, which is configured to connect the biometric device 22 to a mobile device 20 a or client computer 20 b via, for example, a wire or wireless technology, for example, Bluetooth. A bus 450 can connect the various components 410, 420, 430, 440 within the biometric device 22. In accordance with an exemplary embodiment, in most cases, the biometric device 22 does not support Public Key Infrastructure (PKI) as disclosed herein.

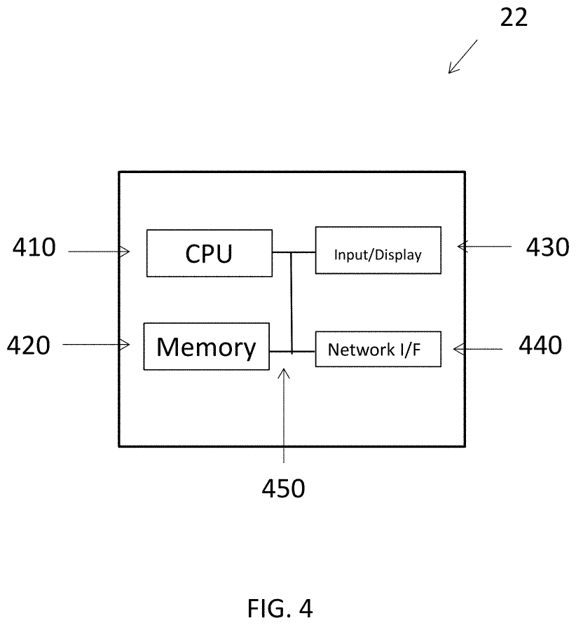

FIG. 5 is an illustration of a multi-function printer (MFP), an imaging forming apparatus, a printer or a printing device 30a, 30b in accordance with an exemplary embodiment. As shown in FIG. 5, the multi-function printer (MFP), imaging forming apparatus, the printer or the printing device 30a, 30b can include a network interface (I/F) 590, which is connected to the communication network (or network) 50, a processor or central processing unit (CPU) 510, and one or more memories 520 for storing software programs and data (such as files to be printed) 522. For example, the software programs 522 can include a printer controller and a tray table. The processor or CPU 510 carries out the instructions of a computer program, which operates and/or controls at least a portion of the functionality of the multi-function printer (MFP), imaging forming apparatus, the printer or the printing device 30a, 30b. The multi-function printer (MFP), imaging forming apparatus, the printer or the printing device 30a, 30b can also include an input unit 530, a display unit or graphical user interface (GUI) 540, a scanner engine (or scanner) 550, a printer engine 560, a plurality of paper trays 570, and a colorimeter 580.

In accordance with an exemplary embodiment, the colorimeter 580 can be an inline colorimeter (ICCU) (or spectrophotometer), which measures printed color patches in order to generate color profiles. In accordance with an exemplary embodiment, for example, the colorimeter (or spectrophotometer) 580 can be one or more color sensors or colorimeters, such as an RGB scanner, a spectral scanner with a photo detector or other such sensing device known in the art, which can be embedded in the printed paper path, and an optional finishing apparatus or device (not shown). A bus 592 can connect the various components 510, 520, 530, 540, 550, 560, 570, 580, and 590 within the multi-function printer (MFP), imaging forming apparatus, the printer or the printing device 30a, 30b. The multi-function printer (MFP), imaging forming apparatus, the printer or the printing device 30a, 30b also includes an operating system (OS), which manages the computer hardware and provides common services for efficient execution of various software programs. In accordance with an exemplary embodiment, it can be within the scope of the disclosure for the multi-function printer (MFP), imaging forming apparatus, the printer or the printing device 30a, 30b to be a copier.

For example, in accordance with an exemplary embodiment, an image processing section within the multi-function printer (MFP), imaging forming apparatus, the printer or the printing device 30a, 30b can carry out various image processing under the control of a print controller or CPU 510, and sends the processed print image data to the print engine 560. The image processing section can also include a scanner section (scanner engine 550) for optically reading a document, such as an image recognition system. The scanner section receives the image from the scanner engine 550 and converts the image into a digital image. The print engine 560 forms an image on a print media (or recording sheet) based on the image data sent from the image processing section. The central processing unit (CPU) (or processor) 510 and the memory 520 can include a program for RIP processing (Raster Image Processing), which is a process for converting print data included in a print job into Raster Image data to be used in the printer or print engine 560. The CPU 510 can include a printer controller configured to process the data and job information received from the one or more servers 10, the one or more mobile clients 20a, or client computers 20b, for example, received via the network connection unit and/or input/output section (I/O section) 590.

The CPU 510 can also include an operating system (OS), which acts as an intermediary between the software programs and hardware components within the multi-function peripheral. The operating system (OS) manages the computer hardware and provides common services for efficient execution of various software applications. In accordance with an exemplary embodiment, the printer controller can process the data and job information received from the one or more mobile clients 20a, or the one or more client computers 20b to generate a print image.

In accordance with an exemplary embodiment, the network I/F 590 performs data transfer with the one or more servers 10, and the one or more client devices 20a, 20b. The printer controller can be programmed to process data and control various other components of the multi-function peripheral to carry out the various methods described herein. In accordance with an exemplary embodiment, the operation of printer section commences when the printer section receives a page description from the one or more servers 10, and the one or more client devices 20a, 20b via the network I/F 590 in the form of a print job data stream and/or fax data stream. The page description may be any kind of page description languages (PDLs), such as PostScript® (PS), Printer Control Language (PCL), Portable Document Format (PDF), and/or XML Paper Specification (XPS). Examples of the multi-function printer (MFP), imaging forming apparatus, the printer or the printing device 30a, 30b consistent with exemplary embodiments of the disclosure include, but are not limited to, a multi-function peripheral (MFP), a laser beam printer (LBP), an LED printer, a multi-function laser beam printer including copy function.

In accordance with an exemplary embodiment, the multi-function printer (MFP), imaging forming apparatus, the printer or the printing device 30a, 30b can also include at least one auto tray or paper tray 570, and more preferably a plurality of auto trays or paper trays. Each auto tray or paper tray 570 can include a bin or tray, which holds a stack of a print media (not shown), for example, a paper or a paper-like product. The printer engine or print engine 560 has access to a print media of various sizes and workflow for a print job, which can be, for example, stored in the input tray. A “print job” or “document” can be a set of related sheets, usually one or more collated copy sets copied from a set of original print job sheets or electronic document page images, from a particular user, or otherwise related.

In accordance with an exemplary embodiment, the print media is preferably a paper or paper-like media having one or more print media attributes. The print media attributes can include, for example, paper color, coating, grain direction, printing technology, brightness, CIE, tint, whiteness, labColor, etc. In order to maximize print quality, the print media attributes of each type of print media should be input into or hosted on the printer 30a, 30b, for example, on printer configuration settings of the multi-function printer (MFP), imaging forming apparatus, the printer or the printing device 30a, 30b to obtain the highest quality output. Most print media is provided in reams or other known quantities, which are packaged with indicia such as information on the manufacture, size, type and other attributes of the print media. In addition, most bundles or reams of paper include a UPC (Universal Product Code) or bar code, which identifies the type of print media including manufacture of the print media.

FIG. 6 is an illustration of an example of a bio-metric user registration process 600 for users with authentication client software in accordance with a current user registration for Solution Vendor A. As shown in FIG. 6, the bio-metric user registration process 600 can include a plurality of client devices 20a . . . 20n, and, for example, a server 610. The server 610 can be configured, for example, to both Solution Vendor A and acts an Authentication Server. The process 600 can also include a corresponding database 620 of users and resources. Each of the client devices 20a . . . 20n can include biometric vendor software 630 and a specific solution vendor application 632 (i.e., Vendor A) for authenticating the client 20a . . . 20n on the authentication server 610 for each Vendor. If the client 20a . . . 20n wishes to register with two or more Vendors, for example, Vendor A and Vendor B, the client 20a . . . 20n is required to have a solution vendor application for each of the Vendors A and Vendor B.

FIG. 7 is an illustration of a client-less registration system 700 in accordance with an exemplary embodiment. As shown in FIG. 7, the client-less registration system 700 can include a solution provider server (i.e., registration server) 710 having a generic registration proxy dispatcher 712 and a solution specific registration handler 714. In accordance with an exemplary embodiment, the solution specific registration handler 714 is configured to handle one or more of solution vendor applications, for example, Solution Vendor A, Solution Vendor B, Solution Vendor C, . . . , and wherein each of the solution vendors includes a registration process for users and biometric device 22 as disclosed herein. The client-less registration system 700 can also include a vendor database (i.e., database server) 720, which is configured to host a database of users and/or resource parameters for each of the plurality of solution vendors, for example, Solution Vendor A, Solution Vendor B, etc. In accordance with an exemplary embodiment, the vendor database 720 is a server, which is configured to host a database of users, biometric devices, and/or resource parameters for each of the plurality of solution vendors, and wherein the vendor database is in communication with the solution provider server.

In accordance with an exemplary embodiment, the client-less registration process 700 can include one or more preconditions for ensuring operability. For example, the one or more preconditions can include the software components 630 of the biometric vendor should be installed on the computing device (client PC) 20a . . . 20n, and the software components should be running. In accordance with an exemplary embodiment, the computing device 20a . . . 20n should have Web browser 640, for example, a standard default browser, and the solution provider server 710 is configured to execute (i.e., run) the generic registration proxy dispatcher 712 and register solution specific registration handler 714 with the generic registration proxy dispatcher 712 so that any appropriate registration requests intercepted by generic registration proxy dispatcher 712 are relayed to the solution specific registration handler 714. In addition, the computing device 20a . . . 20n should have a file 642, which includes the Registration URL address of the solution provider server 710.

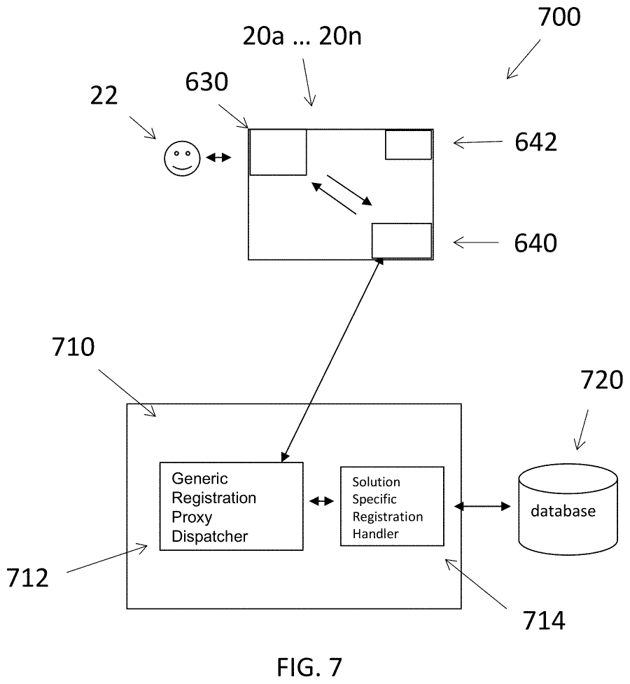

FIG. 8 is a flowchart illustrating a registration process in accordance with an exemplary embodiment. As shown in FIG. 8, the registration process starts in step 810. In step 820, the user performs initiation to begin the user registration process for the biometric device 22, for example, a wearable biometric device. For example, the user wearing a biometric device 22 may move within a predefined distance to the computing device 20a, 20b. In step 830, the biometric vendor software 630 hosted on the computing device 20a, 20b, detects the biometric device 22 does not have any registration profile/data yet, and the biometric vendor software 630 starts the registration process. In step 840, the biometric vendor software 630 reads the file 642 located in the system files of the computing device 20a . . . 20n, whose location is known a priori. In accordance with an exemplary embodiment, the file 642 preferably contains, for example, an HTTPS location URL information of registration end point of the solution provider server 710 (i.e., registration server). In step 850, the default browser 640 on the local device (for example, the computing device 22a . . . 22n) is launched, with the address information loaded with the URL address of the solution provider server 710 from the file 642 as set forth in step 840. In step 850, the default browser sends HTTP POST data to the generic registration proxy dispatcher 712 hosted on the solution provider server 710. In accordance with an exemplary embodiment, the POST request packet can include, for example, the following information:
Header Name: ‘content-type’
Header Value: ‘application/json’
   Payload in JSON format.

In step 860, the browser (on behalf of biometric vendor software) & Generic Registration Proxy Dispatcher talks to each other to communicate registration request, user credential supplying , processing the response etc.

In accordance with an exemplary embodiment, the packet communications convey registration information, for example, as follows:

Registration Request:

Biometric vendor software --→ Generic Registration Proxy Dispatcher

{

″code″ : ″user-register-start″,
“registration-flow-unique id” : “100”

“bio-metric-vendor-details” :

```
{
  “name” : “vendor1”,
  “version”: “version1”
}
```

}

Registration-Initialization Response, User Credential Challenge:

Generic Registration Proxy Dispatcher -→ Biometric vendor software
User is prompted to provide credentials such as user name and password.
POST JSON data

{

″code″ : ″user-credential-challenge″,
“registration-flow-unique id” : “100”

}

Registration Credential Response, User Credential Supply:

Biometric vendor software (via browser) → Generic Registration Proxy
Dispatcher
User supplies credentials such as user name and password.
POST JSON data

{

″code″ : ″user-credential-supply″,
“registration-flow-unique id” : “100”,
“user-name” : “user1”,
“user-password” : “password1”

}

Registration Biometric Device Association Mapping Data, supply biometric device ID (biometric device's media access control address (MAC-address), etc.) or auxiliary device's ID (near filed communication identifier (NFC ID))

```
  Generic Registration Proxy Dispatcher→ Biometric
vendor software (via browser)
  POST JSON data
    {
      ″code″ : ″request-user-device-id″,
      “registration-flow-unique id” : “100”,
        }
```

Registration Biometric Device Association Mapping Data, response in supplying biometric device ID (biometric device MAC-address etc.) or auxiliary device's ID (NFC ID)

Biometric Vendor Software (Via Browser)—>Generic Registration Proxy Dispatcher

```
POST JSON data
Primary device data:
  {
    ″code″ : ″response-user-device-id″,
    “registration-flow-unique id” : “100”,
    “device-mac-id” : “01:02:03:04:05:06”,
      }
  OR
Auxiliary device data:
  {
    ″code″ : ″response-user-device-id″,
    “registration-flow-unique id” : “100”,
    “aux-device-nfc-id” : “012345678912345678899”,
      }
```

Registration Final Response:

```
  Generic Registration Proxy Dispatcher → Biometric vendor
software Success Case
    {
      ″code″ : ″user-register-done″,
      “registration-flow-unique id” : “100”
          “registration-status-code”: “ok”
        }
      OR
Failure Case
    {
      ″code″ : ″user-register-done″,
      “registration-flow-unique id” : “100”
          ““registration-status-code” : “fail”
          ““registration-status-failure-code” : “10”
        }
```

In accordance with an exemplary embodiment, by utilizing the functionality of the generic registration proxy dispatcher 712, the generic registration proxy dispatcher 712, which is compatible with any browser used as a computing device 20a . . . 20n (i.e., client) on behalf of biometric software component, the registration process can be accomplished with the intelligence carried in the packets that are exchanged in the POST data over a transport layer security (TLS) communication. Therefore, several solution vendors can be integrated with biometric solutions without the need for the solution vendors to write their software components and the requirement that the software components be installed on each and every client device 20a . . . 20n. After intercepting the packet from the client device 20a . . . 20n, the generic registration proxy dispatcher allows the port-processed data to the registered (software registration via callback functions) runtime solution-specific user registration handler in the given deployment.

Avoidance of User Re-Registration on Pristine Computing Device

In accordance with an exemplary embodiment, it would be desirable to have a method and system for new user registration and authentication procedures to achieve avoidance of user re-registration on a pristine computing device 20 b. In accordance with an exemplary embodiment, a pristine computing device 20 b can be any client or computing device in which the user and corresponding device tied to the user has not been authenticated via, for example, a mobile device 20a.

As set forth above, currently the biometric based client-server authentication systems have four flows, user registration, user authentication, user roaming authentication, and a user de-register and/or revocation flow. In accordance with an exemplary embodiment, user registration processes involve recording user's profile (for example, credentials, etc.) and the address and information of the biometric device in the solution server, as the server performs user's credentials registration in a secure fashion. For example, the registration of the user's credential can include username and password for credential storing.

In accordance with an exemplary embodiment, when a user uses a platform-authenticator or secure-container (such as a trusted platform module (TPM) chip etc.) hosted by a computing engine (for example, Windows 10, etc.) during the main registration process, the user is also provisioned with a smartcard certificate whose private key can be securely contained in the security container. The authentication server can allow smartcard certificate provisioning to users because the user has been authenticated (i.e., strongly authenticated) at the end of user registration.

In accordance with an exemplary embodiment, when that user happens to roam and use another computing engine (for example, another Windows 10, etc.) the current client server authentication systems force the user and corresponding biometric device 22 to undergo a re-registration process as that computing engine and its platform-authenticator or security container has no security context for the user which was only obtained on the computing engine where the user registered using a username and password. Such a lack of security context arises from the fact that user is not presenting enough credentials to the authenticating server, as strong as the user did during the registration that took place on the previous (prior to roaming) computing engine.

In accordance with an exemplary embodiment, one typical use case for requiring re-registration on the roamed computing engine is when user wants to perform Active Directory (AD) login from this new machine, but requires a smart card certificate to be available on that computing engine which can be obtained via enrollment from the authentication server. However, the authentication server cannot provide smartcard certificate enrollment because the user cannot provide any authenticable context from the new machine. This conventional problem forces the user to re-register (for example, repeat) using user name and password, for each and every machine the user roams to and wants smartcard certificate.

In accordance with an exemplary embodiment, a method and system is disclosed to achieve secure enrolment of smart card certificate without re-registration. In accordance with an exemplary embodiment, a method and system is disclosed that can help security context on a pristine computing engine, without re-registration by user, and wherein the secure authentication or roaming-authentication occurs (i.e., happens) on the pristine machine (for example, a Windows laptop) by using two-factor authentication-secure (2FA-secure) PKI-based authentication with a roaming authenticator, which is available in the close proximity of pristine machine. In accordance with an exemplary embodiment, it would be desirable to have a client server authentication system, which can avoid the necessity of re-registration as disclosed herein.

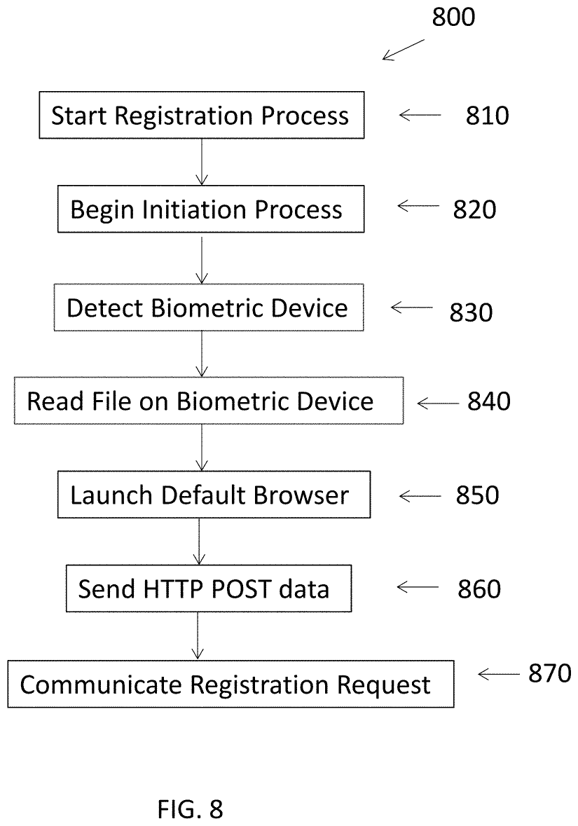

FIG. 9 is an illustration of a registration relationship 900 between primary authenticators 920a, 920b, 920c, and a user roaming authenticator 910 stored in a server (database) in accordance with an exemplary embodiment. In accordance with an exemplary embodiment, as shown in FIG. 9, the user registration relationship 900 can include a central server, which stores, for example, a user roaming authenticator (i.e., child) 910, which is in communication with a plurality of user-registrations with primary biometric authenticators 920a, 920b, 920n, which form a parent-to-child relationship, for example, a many-to-one relationship between the primary user roaming authenticator 910 and the multiple roaming authenticators 920a, 920b, 920c. As disclosed herein, upon the registration of the user and the biometric device 22 with the user roaming authenticator 910 (i.e., child), the user and the biometric device 22 can avoid the re-registration process and obtaining user security on pristine computing engines or pristine computing devices. In accordance with an exemplary embodiment, the pristine computing engines or pristine computing devices can be engines or devices in which the user and biometric device 22 has not previously been registered, or alternatively, for example, for a mobile device 1010, which has not previously been used for authentication. In accordance with an exemplary embodiment, the mobile device 1010 is configured to support PKI as a roaming authenticator as described herein. In addition, the mobile device 1010 is configured to be registered or tied to the user, for example, via a second authenticator, for example, a finger print, password, PIN, Face ID, Touch ID, etc.

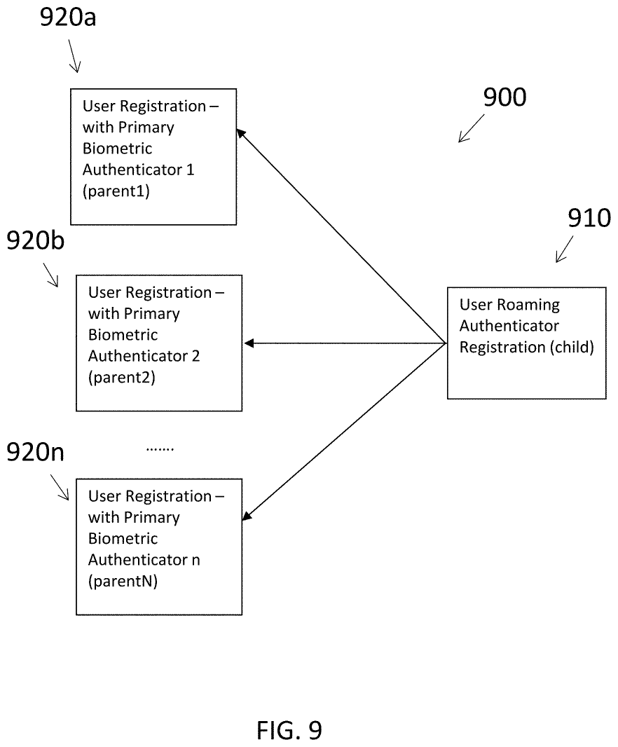

FIG. 10 is an illustration of a system 1000 for user roaming authentication registration having a biometric device 22 (i.e., 1020a, 1020b, 1020c) and a mobile client 1010 in accordance with an exemplary embodiment. As shown in FIG. 10, each of the biometric devices 22 (i.e., 1020a, 1020b, 1020c) can include an solution-specific authentication client software component 1022a, 1022b, 1022c, and optionally, a standard software component for biometric authorization 1024a, 1024b, 1024c. In accordance with an exemplary embodiment, the solution-specific authentication client software component 1022a, 1022b, 1022c can be configured to communicate with a solution-specific application (or software) 1012 hosted on a mobile roaming authenticator, for example, a mobile device 1010.

In accordance with an exemplary embodiment, communications between the main authentication client on the computing device (for example, a personal computer (PC) and the solution specific application 1012 on the roaming authenticator 1010 can be via wireless, for example, running a regular RESTful communication. In accordance with an exemplary embodiment, the solution specific application on the mobile device 1010 can be configured to acts as companion to the main authentication client (on computing device or personal computer (PC)) to help achieve authentication on the computing device (or PC).

In accordance with an exemplary embodiment, at the end of current registration flow of any given client-server based secure authentication systems, the user can be given the choice to add a set of roaming authenticators to reduce the need to authenticate each and every computing device 20a . . . 20n. In accordance with an exemplary embodiment, roaming authenticators can be, for example, either an Android mobile device or iOS mobile device 20a. In accordance with an exemplary embodiment, the iOS mobile device can be, for example, an iPhone®.

In accordance with an exemplary embodiment, the Android mobile device should support Keystore, and iOS should support Keychain. If the user has either an Android mobile device or an iOS, which supports Keychain, in accordance with an exemplary embodiment, the user can consent to the method and systems as disclosed for authentication without re-registration. In accordance with an exemplary embodiment, during this additional registration the authentication server establishes a PKI-Credential to all of the user's main biometric registrations. For example, during the registration flow, as a first step, the server verifies the attestation of PKI credential resident (iOS or Android device). In addition, the authentication flow utilizes an new interaction between a main registration client and companion mobile application to securely send the crypto-based user assertion that is verified, for example, in 2FA fashion at the roaming authenticator 910 (FIG. 9).

FIG. 11 is a flow chart showing a registration flow in accordance with an exemplary embodiment. As shown in FIG. 11, the system 1100 includes a solution specific main registration client, for example, a personal computer or computing device 1102, which includes, for example, an application running on Windows, or iOS, for example, for hardware made by Apple Inc. The system 1100 also includes a solution specific application hosted for example, on a mobile device 1010, for example, having an Android or iOS operating system, and an authentication server 900. In accordance with an exemplary embodiment, the mobile device 1010 has a platform that is configured to support Public Key Infrastructure (PKI).

As shown in FIG. 11, in step 1110, the user registers a biometric device 22 via, for example, standard user registration on the computing device 1102. In step 1112, the registration digital artifact for the user from the biometric device 22 can be sent directly to the authentication registration server 910. In step 1120, the authentication registration server 910 can provision the user to have roaming authentication (i.e., a roaming authenticator), and the authentication server can initiate registration of the roaming authenticator by sending a message, that includes unique random code to the computing device 1102. In accordance with an exemplary embodiment, the unique random code can be numbers, letters, symbols and/or a combination of letters, numbers, and/or symbols. In step 1122, the computing device 1102 receives the message from the authentication server, and the user can register Roaming PKI credential hosted by roaming authenticator mobile device, for example, by clicking on a message received by the computing device 1102. For example, in accordance with an exemplary embodiment, the computing device 1101 can be configured to display via a pop-up display the unique random code sent by the authentication registration server 910.

In accordance with an exemplary embodiment, in step 1130, the user starts the solution specific application hosted on the mobile device 1010, and enters the unique code displayed on the computing device 1102, and in step 1132 sends RESTful message to the main registration client hosted on the computing device 1102. In step 1140, the received message from the mobile device 1010 is relayed to the authentication server 900 to start the registration process for the mobile device 1010 (mobile roaming authenticator). In step 1150, the authentication server creates a Public Key Infrastructure (PKI) Credential (challenge), which is sent to the computing device 1102. In step 1160, the created PKI Credential (challenge) is forwarded from the computing device 1102 to the mobile device 1010. In step 1170, the mobile device 1010, generates a Key Pair and signs the Challenge. In step 1172, the mobile device 1010 sends the Public Key and Android/iOS Attestation Certificate to the computing device 1102. In step 1180, the computing device 1102 relays the received crypto message to the authentication server, wherein the relayed message can include the Signed Challenge+Public Key+Attestation.

In accordance with an exemplary embodiment, in step 1182, the attestation is verified by the authentication registration server 910 with Android/iOS attestation certificate authority (CA), then challenge is verified against received public key, which registers the roaming authenticator. In step 1184, the Public Key (Roaming PKI Credential) credential is linked against all existing primary biometric registration database entries.

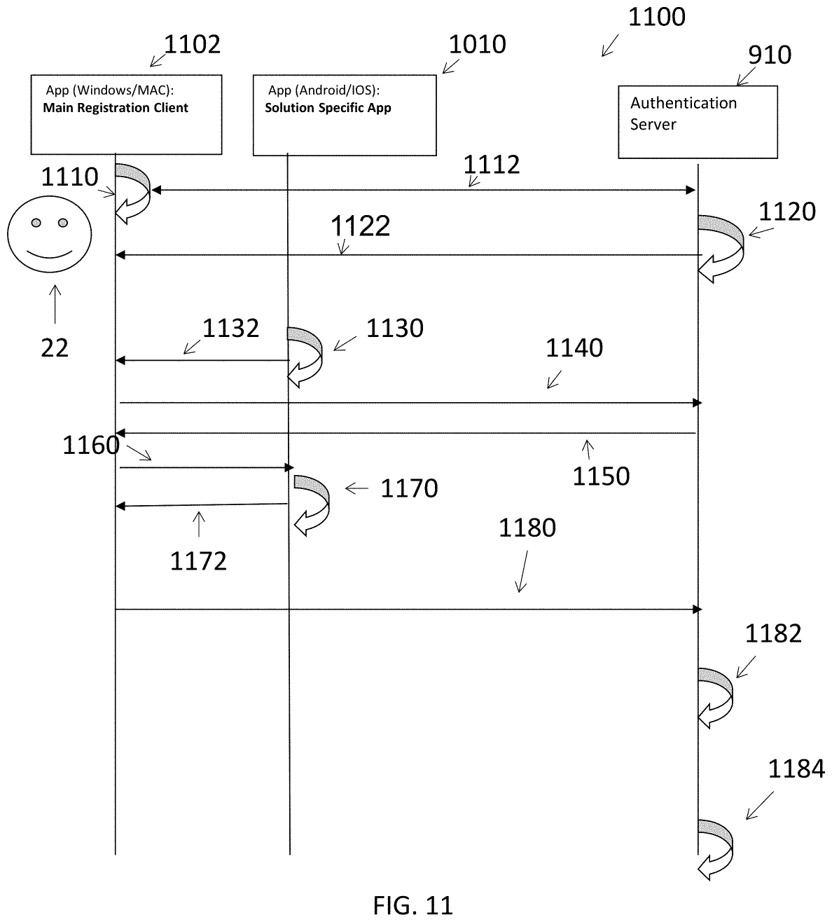

FIG. 12 is a flow chart showing a registration flow in accordance with another exemplary embodiment. As shown in FIG. 12, the system 1200 includes, for example, a solution specific main registration client, for example, a personal computer or computing device 1102, which includes, for example, an application running on Windows, or iOS, for hardware made by Apple Inc. The system 1200 also includes a solution specific application hosted for example, on a mobile device 1010, for example, having an Android or iOS operating system, and an authentication server 900.

As shown in FIG. 12, in step 1210, the user indicates intent to attain two-factor authentication (2FA) authentication context on pristine PC/MAC with the mobile device 1010 (mobile roaming authenticator), which intent is sent from the computing device 1102 to the authentication server in step 1212. In step 1120, the authentication server 900 checks to determine whether the user is already provisioned with the roaming authenticator. If the user is already provisioned with the roaming authenticator, and the user wishes to attach 2FA authentication, the authentication server generates a unique random code (i.e., code) and send a response message with the unique random code (i.e., code) to the computing device 1102. In step 1122, the computing device 1102 receives the response message from authentication server 900, and the user receives a message, for example, via a display that indicates “2FA-Strong-Authenticate Via Roaming PKI credential” (i.e., two-factor authentication via roaming PKI credential) hosted by the mobile device 1010. In accordance with an exemplary embodiment, the computing device 1102 can have a display with a pop-up display, which displays, for example, the unique random code sent by the authentication registration server 910.

In step 1230, the user on the mobile device 1010 starts the solution specific application and enters the unique random code displayed on the computing device 1102, which was received from the authentication registration server 910. In accordance with an exemplary embodiment, the unique random code can be numbers, letters, symbols and/or a combination of letters, numbers, and/or symbols. In step 1232, the mobile device 1010 sends RESTful message to the solution specific main registration client on the computing device 1102. In step 1240, if the supplied unique random code sent by mobile application matches the unique random code, the process continues by asking mobile app to generate crypto-based user assertion.

In step 1250, the user is prompted to unlock a secure container (for example, Android: Strong Box/Android KeyStore, or iOS: keychain) by requesting the user to enter, for example, a fingerprint, personal identification number (PIN) and/or password. The solution specific application can be configured to prepare signed (using user private key) assertion on the set of user details, for example, username, and encrypts the assertion using server's CA public key. In step 1252, an encrypted message as a response is sent to the solution specific main registration client on the computing device 1102.

In step 1260, the received crypto message is relayed to the authentication server, for example, as a message, for example, Encrypted(SignedAssertion(userpricipalName, signed-with-user privatekey),encrypted-with-server's public key)). In step 1270, the authentication server processes the message and decrypts the assertion using server's CA private key, and verifies the resultant decrypted assertion using User's Public Key (available at Registration phase) in the PKI-credential anchor chain. In step 1280, the user is authenticated, for example, user is 2FA authenticated at Solution Specific Main Registration Client as user is 2FA verified by companion mobile roaming authenticator, and smartcard certificate enrollment and all other secure privileges are now authorized by the authentication server 1280.

Universal Roaming Via Captive Authentication

User registration process involves recording user's profile (for example, credentials, etc.) and the associated biometric device address information in the server, as the server performs user's credentials registration in a secure fashion. Typically, username and password can be used for storing credentials of the user.

As set forth above, currently the biometric based client-server authentication systems have four flows, a user registration flow, a user authentication flow, a user roaming authentication flow, and a user de-register/revocation flow. Out of these flows, the user roaming authentication flow can present constraints to the user, for example, during authentication, where the user is restricted to avail provisioned end services only on that computing machine hosting the authenticator. Thus, this one-to-one mapping forces the user to have multiple registrations.

For example, if the user chooses to use an Android and/or iOS device as an authenticator, the user performs user registration on that device (using fingerprint/PIN/Touch ID/Face ID, etc.) that talks to the authenticating server. After registration, the user can use that device to authenticate and avail provisioned services. However, the user cannot use another device/computing engine (for example, the device or computing has bigger display/real estate) to access services.

Thus, the user has no choice, but to use the same registered device to be used in authentication phase to receive provisioned services. For example, the user suffers constraints on which kind of computing machine the user (i.e., he/she) can avail roaming authentication. In general, these constraints are as a result of the roaming authenticators and the restrictions of the roaming authenticators can include that the roaming authenticator don't support, for example, certain operating system (OS)/platforms, or for the OS/platforms they support, each need a special driver to be installed on the computing machine where the user avails the services hosted on the OS/platform. Thus, users are limited to only certain platforms, which are supported by varying set of authenticators.

For example, a roaming biometric authenticator indicates that RA1 (i.e., roaming authenticator 1) works with authenticating server (AS), and wherein, RA1 is supported on Windows and Linux. Once the user registration is performed on any computing engine that is based on Windows or Linux, the user (i.e., he/she) can get authenticated on any compatible computing engine. For this to be successful, the authenticating machine should have all corresponding software, firmware and driver components installed. However, the user (i.e., he/she) cannot authenticate on a computing engine based on MAC OS.

For example, for ‘N’ number of roaming biometric authenticators, the users must install different software, firmware and driver components, and the users may still face a degree of incompatibility.

In addition, users can be limited to avail or access services in one mode. For example, the user registered his Android phone with a server. When the user (i.e., he/she) authenticates with the system using the registered phone, the user (i.e., he/she) can only receive the services on that device. If he wants to choose to avail services (for example, in a secure 2FA manner) on a device that has bigger display, the current technology has no solution.

Furthermore, the user may suffer poor performance (speed) of roaming authentication flow, for example, the relative high latency can be purely caused by just how several software components are designed to interact.

Accordingly, it would be desirable to have a method and system, which applies to any kind of comprehensive network security systems offering secure authentication and service authorizations solutions for the enterprise users, and which helps solve the traditional problems faced by current industry as set forth above.

In accordance with an exemplary embodiment, universal captive roaming authentication can be achieved with a one-time multiple-registration chain with PKI-credential anchoring, dual-mode feature, which can include: resident-authenticate services on resident device experience, and roaming-authenticate services on foreign devices, and wherein both dual mode features are available at the same time to a user, or alternatively, the user can select only one of dual-mode features. In addition, the universal roaming authentication can include a universal roaming experience, relatively fast roaming authentication, and interoperability.

In accordance with an exemplary embodiment, the registration flow can include at the end of current registration flow of any given client-server based secure authentication systems, the user can be given the choice to add set of captive roaming authenticators. In accordance with an exemplary embodiment, the captive roaming authenticators can be, for example, an Android mobile device or iOS mobile device. For example, an Android device should be able to support Keystore, and iOS should be able to support Keychain. If the user has either of those types of devices (i.e., an Android or iOS based mobile device) and the user consents, then the authentication server can establish an Anchor PKI-Credential chained to the user's (i.e., his/her) main registration. In accordance with an exemplary embodiment, for example, for each captive roaming authenticator user attempts to add, a PKI-Credential can be anchored to the existing per-user credential chain. For example, in accordance with an exemplary embodiment, during the registration flow the server, as a first step, verifies the attestation of PKI credential resident (iOS or Android device).

In accordance with an exemplary embodiment, in the captive roaming authentication flow, the user using a client device (for example, Android or iOS mobile device) that supports captive roaming authentication, and uses a software application running a captive roaming authentication (CRA) protocol, and places the client device, for example, a mobile device 1102 a close (i.e., with a predefined distance) to any computing device (for example, a computer running Windows, MAC, or Linux) where the user wants to obtain an authenticated state, and once authenticated, the user is able to avail or access secure service access authorizations.

In accordance with an exemplary embodiment, the computing device should be running the service or application that acts as a captive roaming authentication protocol peer (i.e., CRA protocol peer). As soon as these applications running a CRA protocol execute a handshake, the user can be prompted to unlock a secure container (for example, Android: Strong Box/Android KeyStore, or iOS: keychain) using an authenticator, for example, finger print/Touch ID/Face ID/PIN.

Note that all these authenticators act as a 2^{nd} Factor authentication (i.e., two-factor authentication (2FA)) while the 1^{st} factor being the private key contained securely in the mobile device's secure container. In accordance with an exemplary embodiment, as soon as user performs the 2^{nd} factor authentication, the mobile application sends the signed assertion (encrypted with user's private key) carrying, for example, the user's email identifier (ID), which is encrypted with server's public key. In accordance with an exemplary embodiment, such an assertion can be silently relayed by the CRA protocol-peer app/service on the computing engine (for example, Windows, MAC, or Linux) by launching any standard system browser (for example, Chrome, Firefox, Safari, etc.) and posting the encrypted signed assertion to the authentication server, and waiting for a server response (for example, success or failure). In accordance with an exemplary embodiment, this silent, relatively quick and seamless relay by the application or service can be called captive roaming authentication. Apart from tapping the biometric device nearby the computing engine, the use of the biometric device is not expected to perform any action other than, for example, performing a 2^{nd} factor authentication.

In accordance with an exemplary embodiment, the authentication server can be configured to, for example, decrypt the signed assertion using server's (CA) private key, and verify the assertion using user's (whose identity is available from HTTP information) public key in the PKI-anchor chain. In accordance with an exemplary embodiment, the authentication server can assert that the user is authenticated and creates, for example, a JSON Web Token (JWT) and supplies a session cookie to the browser on the computing engine. In addition, the user can be provided with cloud based (like SAML) and on-premise based services (i.e., locally based services). Furthermore, optionally other enrollments can also be offered.

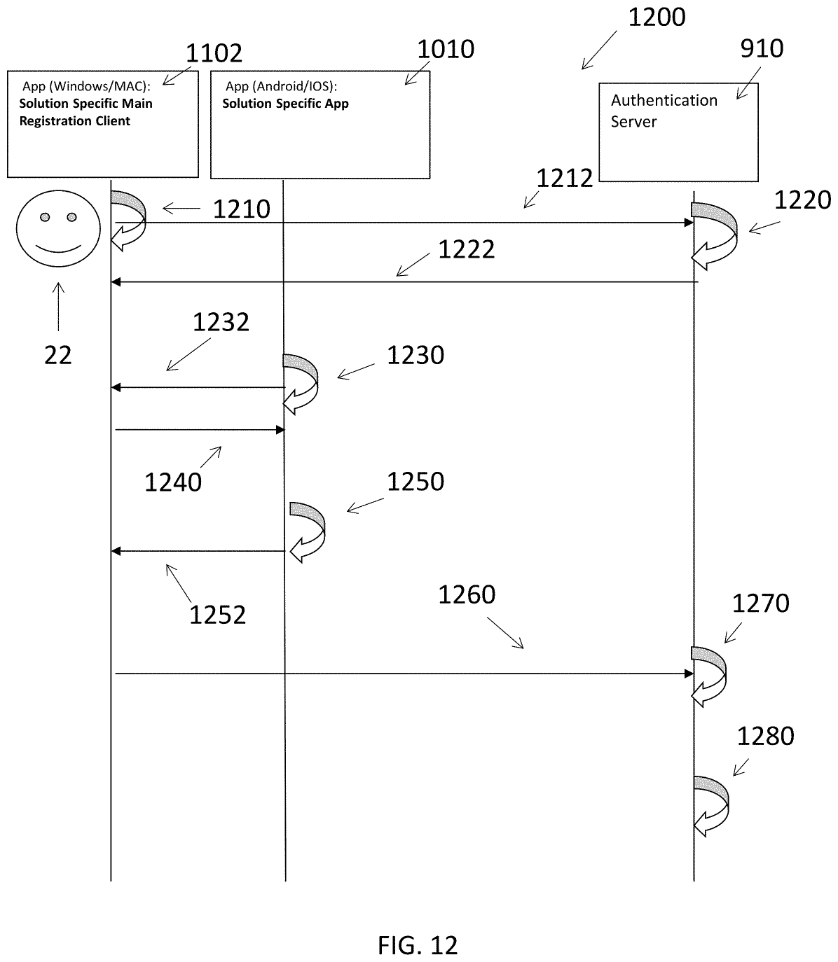

FIG. 13 is a flow chart showing a registration flow in accordance with an exemplary embodiment. As shown in FIG. 13, the system 1300 includes, for example, a main registration client, for example, on a personal computer or computing device 1102, which includes, for example, an application such as Windows, or iOS, for hardware made by Apple Inc. The system 1300 also includes a captive roaming authentication (CRA) application, which is hosted, for example, on a mobile device 1010, for example, having an Android or iOS operating system, and an authentication server 900. In accordance with an exemplary embodiment, the captive roaming authentication (CRA) application is configured to run captive roaming authentication (CRA) protocol as disclosed herein.

In accordance with an exemplary embodiment as shown in FIG. 13, in step 1310, the user finishes standard user registration, for example, with a biometric device 22, or other user registration. In step 1320, the authentication server 910 has the registration digital artifact for the user and corresponding biometric device 22 via the authentication in step 1310. In step 1330, the user is provisioned with captive roaming authentication service, wherein the authentication server 910 sends, for example, an email or a SMS message to user to start captive roaming authentication registration. In step 1332, the mobile device 1010 receives the message from the authentication server 910, and the user, for example, clicks on the message to register the mobile device 1010 as a captive roaming authentication device. In step 1340, the user starts the registration process from the mobile device 1010 by sending a request.

In step 1350, the authentication server receives the request from the mobile device 1010 and creates a PKI User Credential (challenge), which is sent to the mobile device 1010. In step 1352, the mobile device 1010 generates a Key Pair and signs the challenge. In step 1360, the mobile device sends the signed Challenge, the Public Key, and an Android/iOS attestation certificate to the authentication server 910. In step 1370, the authentication server 910 receives the Signed Challenge+Public Key+Attestation, and performs attestation verified by server with Android/iOS attestation certificate authority (CA), the Challenge is verified against received public key, and which at this point a captive roaming authenticator is registered. In step 1380, an Anchor/Link to the Public Key (Roaming PKI Credential) credential against the primary registration artifact for the user (i.e. he/she) is established with main registration client registration flow. In accordance with an exemplary embodiment, at this point the user is FREE, i.e., the user doesn't need the same main registration client when the user (i.e., he/she) wants to be authenticated, and the user can go to any machine with an NFC reader and be authenticated.

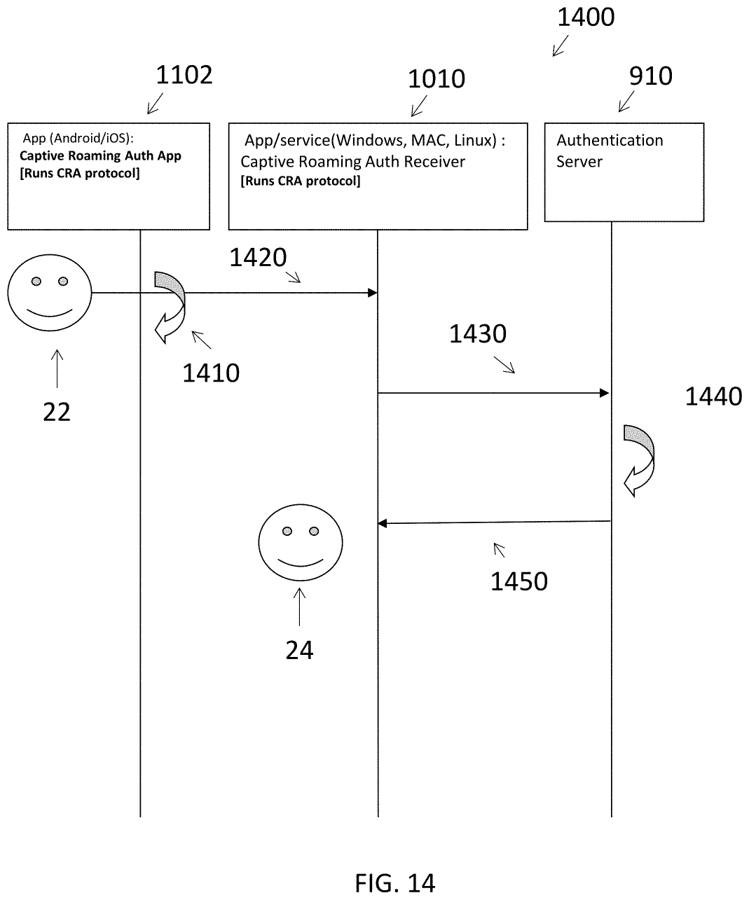

In accordance with an exemplary embodiment, steps 1330 through 1380 repeat, for every captive roaming authentication (CRA) device the user wants to add (i.e., access), and wherein the authentication server 910 registers a credential chain of length 1 or more, per user, for example, as shown in FIG. 15.

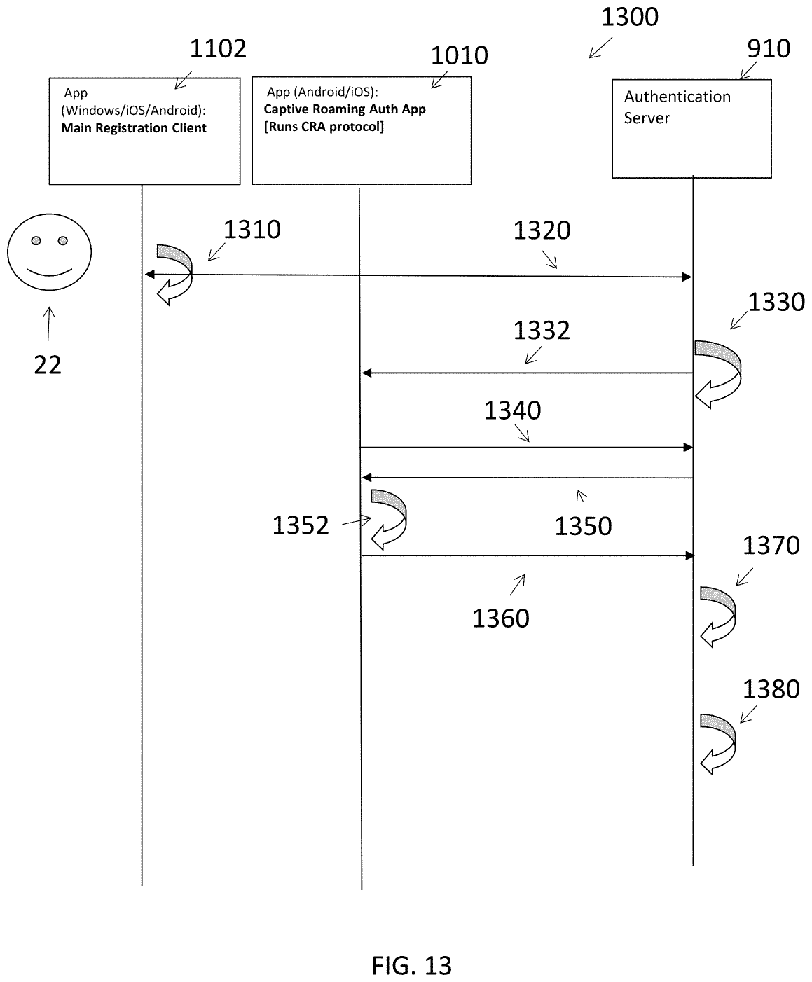

FIG. 14 is a flow chart showing a registration flow in accordance with another exemplary embodiment. As shown in FIG. 14, the system 1400 includes, for example, a captive roaming authentication (CRA) application, for example, a personal computer or computing device 1102, which includes, for example, an application such as Windows, or iOS, for hardware made by Apple Inc. The system 1400 also includes a captive roaming authentication receiver, which is hosted, for example, on a mobile device 1010, for example, having an Android or iOS operating system, and an authentication server 910. In accordance with an exemplary embodiment, the captive roaming authentication application and the captive roaming authentication receiver are both configured to run captive roaming authentication (CRA) protocol as disclosed herein.

As shown in FIG. 14, in step 1410, the user and the biometric device 22 executes a near field communication tap, confirms that captive roaming authentication (CRA) protocol-peer is available, and prompts the user to unlock a secure container (for example, Android: Strong Box/Android Keystore, iOS: Key Chain) by demanding the user (i.e., him/her) to enter, for example, an authenticator (for example, fingerprint and/or personal identification number (PIN)). The captive roaming authentication application then prepares a signed (using, for example, user private key) assertion on the set of user details, for example, username. The assertion can then be encrypted, for example, using the authentication server's CA public key. The computing device 1102 sends out in step 1420, the NFC Data Exchange Format (NDEF) record-based ‘beam’ message containing the encrypted message to the mobile device 1010.

In step, 1430, the mobile device starts a request, for example, “CaptiveCredentialRoaming Authentication”, and obtains authentication server 910 details, and constructs, for example, a URL, i.e., “LetMeRoamServer URL”. In accordance with an exemplary embodiment, the received NFC record will have signed content as Assertion [username]. This assertion is signed by user Credential's private key inside a secure container, for example, such as Strongbox/Android: KeyStore. The assertion can be encrypted, for example, by Server Authentication Public key, and encrypted assertion is sent to the authentication server 910. In step 1440, the authentication server 910 processes the GET request, decrypts the assertion using the server's CA private key, and verifies the resultant decrypted assertion using the User's Public Key (available at Registration phase) in the PKI-credential anchor chain. In step 1450, if the transaction is successful, the computing device 1010 (i.e., user 24) is advised that the transaction was successful.

In accordance with an exemplary embodiment, the user 24 can be two-factor authentication (2FA) roaming authenticated. For example, the user can be presented with a services page gallery, in which the user can access SAML and OpenAPI services. Optionally, the authentication server can ask the user if he/she wants to enroll for Smart Card Logon certificate for On-Premises Domain Access promotion.

FIG. 15 is an illustration of a onetime multiple-registration chain 1500 with PKI-Credential Anchoring for a user (user ‘m’) 22 in accordance with an exemplary embodiment. As shown in FIG. 15, the user (user ‘m’) 22 can supported as per registration flow sequence diagram, which sequence is repeated for every roaming authenticator user is provisioned (for example, Authenticator 1 1510, Authenticator 2 1520, . . . , Authenticator N 1530). In accordance with an exemplary embodiment the authentication server 910 maintains per user PKI anchor chain for holding a set of multiple PKI Credential roaming authenticators and main authenticator through a biometric-based registration.

In accordance with an exemplary embodiment, for example, as shown in FIG. 15, the authentication server 910 supports ‘M’ number of users, and wherein user ‘m’ is one of the users in that set of users. Each user can have ‘N’ authenticators 1530 registered that are chained. In accordance with an exemplary embodiment, any of these ‘N’ can be a mixture of primary biometrics-based authenticator registration and PKI-credential based roaming authenticators.

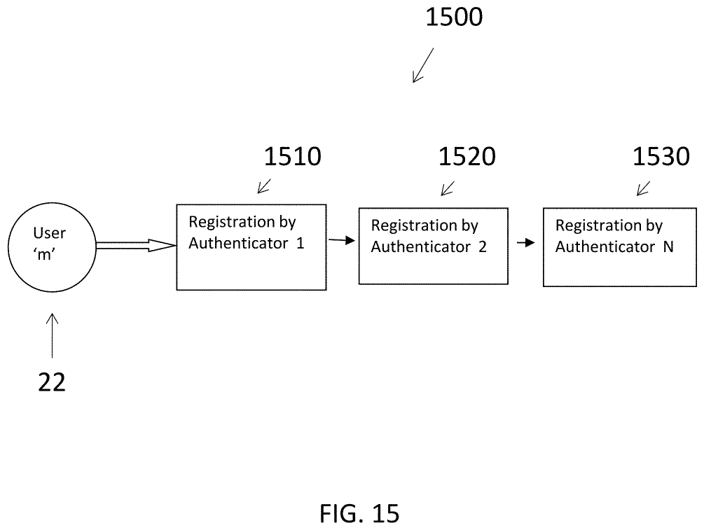

FIG. 16 is an illustration of a system in which a user can experience universal roaming experience in accordance with an exemplary embodiment. As shown in FIG. 16, the system 1600 can include a biometric device 22, an authentication server (or authenticating server) 910, one or more computing devices 1010a, 1010b, 1010c, 1010d, and one or more mobile devices 1102a, 1102b. In accordance with an exemplary embodiment, the user is free to roam across a set of different computing engines with variety of operating systems (OS), for example, Windows, MAC and/or Linux, which is premised on the fact that the mobile device (and user) has roaming authentication based on the user's PKI-credential.

As shown in FIG. 16, in step 1610, the user (and mobile device) is registered using a computing device, for example a Windows personal computer (PC). In step 1620, the user via the computing device 1010a and the authentication server 910 through a registration process and exchanges as disclosed herein. Alternatively, in step 1630, a direct registration can also be performed between the mobile device 1102a and the authenticating server 910. In step 1640, user can be authenticated on iOS tablet 1010d via a mobile device 1102a. Once the user has been authenticated on the iOS device, for example, the iOS tablet 1010d, services are provisioned to the user, for example, on the iOS tablet 1010d.

In accordance with an exemplary embodiment, steps 1610, 1620, 1630 can be performed on any client device 20a, 20b, which runs (i.e., executes) the captive roaming authentication protocol, and wherein the client device 20a, 20b, can be, for example, a mobile client 20a, 1102a, a computing device 1010a, 1010b, 1010c, 1010d, 1102b, and/or a multi-function printer 30a, 30b. In accordance with an exemplary embodiment, steps 1640 can be performed on a computing device which also runs (i.e., executes) the captive roaming authentication protocol, for example, a computing device 1010a, 1010b, 1010c, 1102b, 1102c, and/or a multi-function printer 30a, 30b.

In accordance with an exemplary embodiment, the user performs the registration on his mobile device 1102 (for example, an Android phone). At this point the authentication server 910 has the user's PKI credential anchored to the existing chain that has the linked list of prior users and authenticator's credentials registration information for the prior users. If the user decides to go to an iOS device 1010d (for example, an iPad Pro) that has bigger display real estate to view his provisioned services, instead of using his mobile phone 1102a (which the user registered with the authentication server 910 during step 1610). However, if the iPad Pro does not have any security context for user to present to the server, this is where the captive authentication triggers to seamlessly attain the security context for the user.

In accordance with an exemplary embodiment, the user moves into relative close proximity (i.e., within a predefined distance) to the iPad Pro. The CRA protocol peers on both the Android mobile phone 1102a and the iPad Pro 110d communicate with each other, 2FA process on mobile phone is executed, and the authentication server 910 receives crypto-based user assertion, which the authenticating server 910 can verify and conclude that the user is authenticated. In accordance with an exemplary embodiment, since the user is authenticated, the authenticating server 910 can generate a cookie and redirect the browser session to the user with provisioned services being availed on the iPad Pro 1010d.

In accordance with an exemplary embodiment, as disclosed herein, the user can achieve universal roaming authentication without a complex set of biometric provider's and solution vendor's client side software components. Thus, the user can get high performance (speed) of roaming authentication flow. For example, using the thin service/app that runs a relatively simple CRA protocol that launches the browser, which brings the functionality provided by other complex software systems that exist today.

In accordance with an exemplary embodiment, as per the sequence diagram for roaming authentication flow as shown in FIGS. 13 and 14, the total time taken from the time user starts roaming authentication to the time the user (i.e., he/she) is authenticated and is given services can be calculated as:
Time taken for CRA protocol packet via NFC-record message from device to computing engine+
Time taken for launching browser+
Time taken for sending HTTP POST message to Server+
Time taken by Server to perform PKI operation [decrypt message+verify assertion]+
Time taken by HTTP response back to computing engine with set of services.

In accordance with an exemplary embodiment, the disclosed CPA protocol can be theoretically faster compared with any other roaming authentication flows, which are similar client-server based security systems architectures that offer the same level of security strengths.

In accordance with an exemplary embodiment, the method and system for universal roaming has the interoperability brought by the goal of the CRA protocol. In accordance with an exemplary embodiment, the CRA protocol can allow for interworking of any set of applications and/or services on computing engines with any set of mobile devices that support secure container. In addition, the CRA protocol also provides for other means of transport/communication channels, other than NFC as long as the peers talk the CRA protocol, the captive authentication roaming can be tangible.

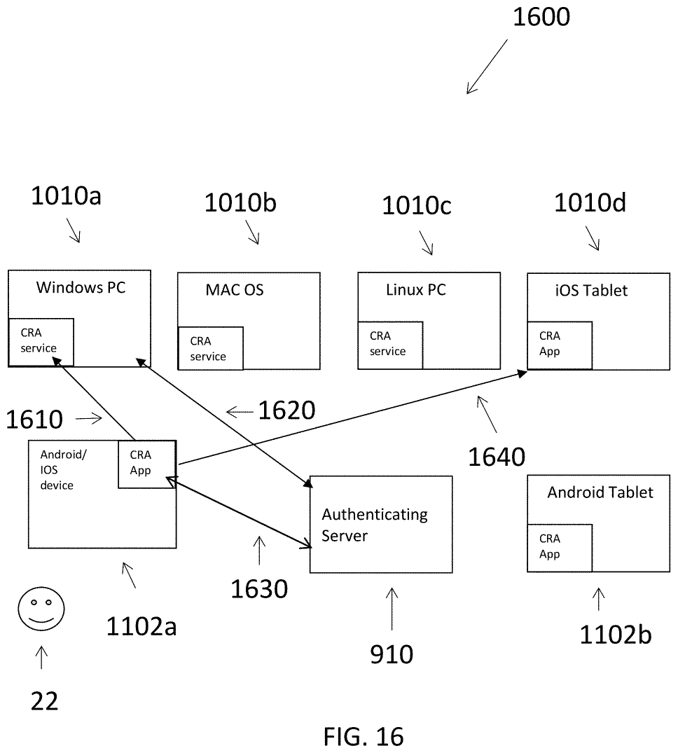

FIG. 17 is an example of the protocol format of an NFC protocol stack 1700 in accordance with an exemplary embodiment. As shown in FIG. 17, the NFC protocol stack 700 can include an Application Layer, a Logical Link Layer, a Media Access Control Layer, and a Physical Layer.

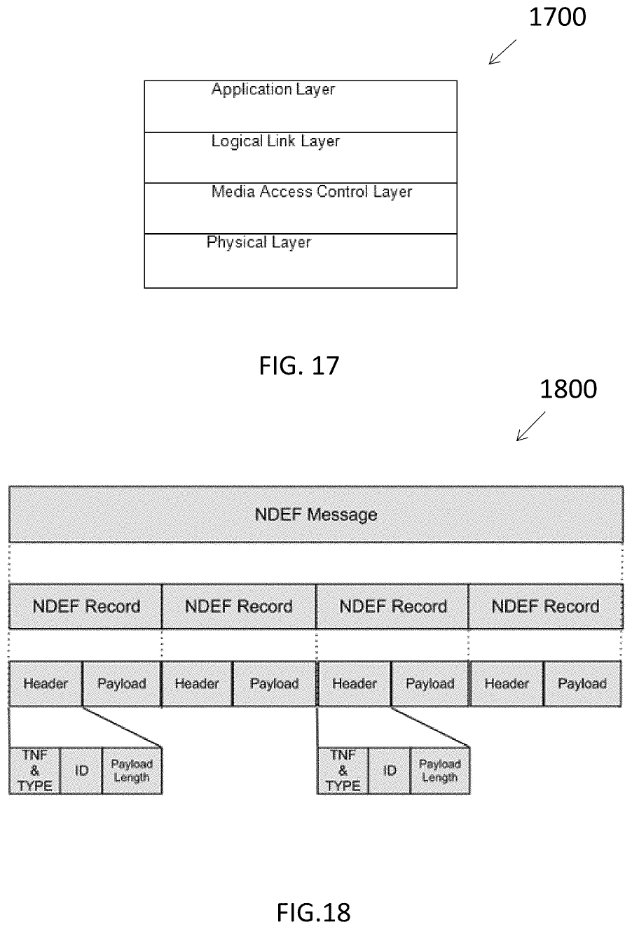

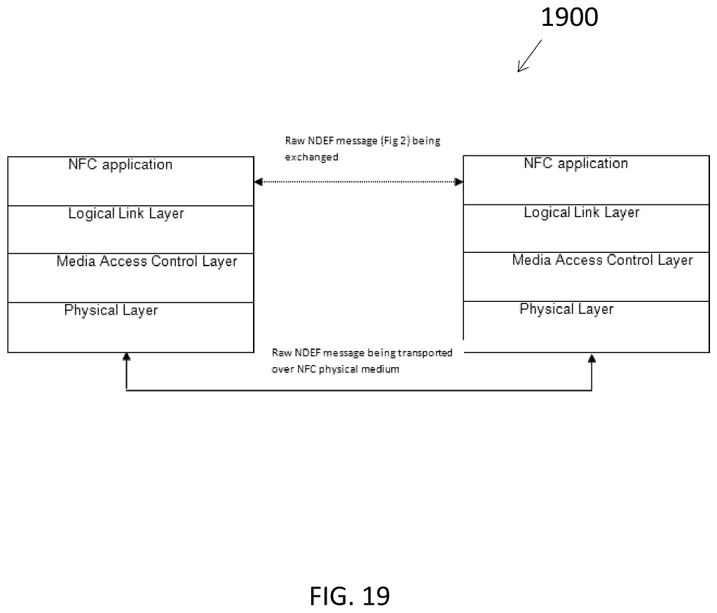

FIG. 18 is an NFC message format 1800 and wherein the NFC message contains multiple NFC records and FIG. 19 shows communications 1900 between NFC peers.

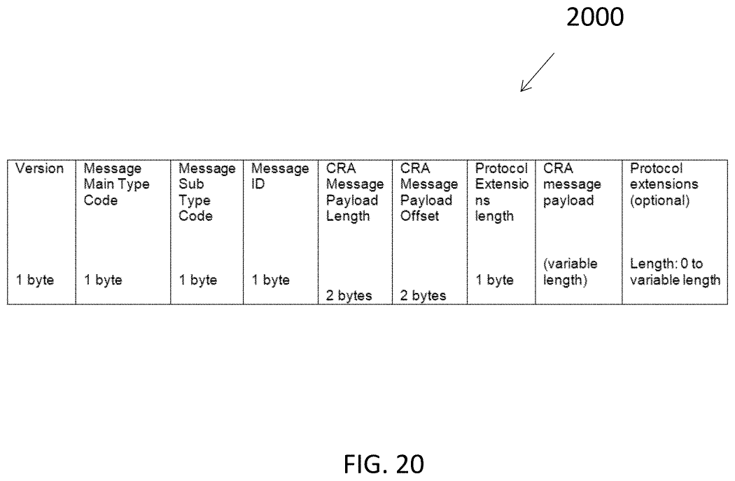

In accordance with an exemplary embodiment, as shown in FIG. 20, the CRA protocol 2000 can offer an abstraction required for Registration flows and Roaming Authentication flows and interoperability across different platforms and different authenticators. For example, in accordance with an exemplary embodiment, the version conveys the version of the protocol (for example, 1, 2, etc.) so that peers understand how to handle any new features.

In accordance with an exemplary embodiment, the protocol can be as follows:
Message Main Type Code

0x01: Registration Request

0x02: Registration Response

0x03: Roaming Authentication Request

0x04: Roaming Authentication Response
Message Sub Type Code

0x01: PKI Attestation Object (that attests resident authenticator)

0x02: Public Key Object

0x03: Challenge

0x04: Challenge Response

0x05: Signed User Assertion with No encryption

0x06: Signed User Assertion with Encryption

In accordance with an exemplary embodiment, the CRA message, for example, can be per the Registration and Authentication flows CRA message in the protocol contains cryptographic messages between Android/iOS device (CRA-compliant authenticator) and the Authentication Server, these message can be silently relayed by CRA protocol-peer on the host device (with NFC reader) upon user's intent through, for example, an NFC tap with the biometric device 22.

In accordance with an exemplary embodiment, messages are either (choice is given for interoperability):

1. Cryptographically Signed User Assertion without any Encryption. Signing is done by simply encrypting the information of user/principal who is authenticating.
User assertion signed by User's private key
Example: Sign (info=piece of information that has user's email as ‘user1@test.com’, with=user's private key securely contained in the device).
   or,

2. Cryptographically Signed User Assertion and the resulted signed assertion Encrypted with server's public key.
User assertion signed by User's private key and then encrypted.
Encrypt (info=Sign(info=piece of information that has user's email as ‘user1@test.com’, with=user's private key securely contained in the device), with=Authenticating Server's public key available via its CA publication)

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present disclosure may be implemented such that its software part has been written onto a recording medium in advance and will be read as required in operation.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for avoidance of user re-registration, the method comprising:
registering a user and a biometric device on a computing device;
sending a registration digital artifact for the user and the biometric device to an authentication server;
registering a mobile device configured to support Public Key Infrastructure (PKI) as a roaming authenticator, the mobile device being registered or tied to information related to the user; and
provisioning the user and the mobile device with roaming authentication, the roaming authentication being accessed through the mobile device and configured to provide the user and the mobile device access to computing devices in which the user and the mobile device have not previously been used for authentication.

2. The method of claim 1, further comprising:
initiating registration of the roaming authentication for the user and the biometric device by sending a message with a code to the computing device upon receipt of the registration digital artifact for the user and the biometric device on the authentication server;
receiving the message with the code from the authentication server on the computing device; and
registering a roaming Public Key Infrastructure (PKI) credential hosted on the authentication server on the computing device.

3. The method of claim 2, wherein the registering of the PKI credential hosted on the authentication server on the computing device comprises:
initiating a solution specific application hosted on the mobile device;
entering the code from the message received by the computing device into the solution specific application;
sending a RESTful message from the mobile client to a main registration client hosted on the computing device;
relaying the RESTful message received from the main registration client hosted on the mobile device to the authentication server; and
starting a registration process for the user and the biometric device on the authentication server.

4. The method of claim 3, further comprising:
creating a PKI Credential (challenge) on the authentication server;
sending the created PKI Credential (challenge) to the computing device; and
forwarding the created PKI Credential (challenge) from the computing device to the mobile device.

5. The method of claim 4, further comprising:
generating a Key Pair and signing the created PKI Credential (challenge) on the mobile device;
sending a Public Key and an attestation Certificate to the computing device in an encrypted message from the mobile device; and
relaying the encrypted message from the computing device to the authentication server, wherein the relay encrypted message includes the signed PKI Credential (challenge), the Public Key, and the attestation.

6. The method of claim 5, further comprising:
verifying the signed PKI Credential (challenge), the Public key, and the attestation on the authentication server; and
linking the Public Key as a roaming PKI Credential in a plurality of biometric registration database entries.

7. The method of claim 1, further comprising:
provisioning the user and the biometric device with a two-factor authentication (2FA), the two-factor authentication including the biometric device as a first authenticator, and a second authenticator.

8. The method of claim 7, wherein the provisioning of the 2FA comprises:
sending a request for the user and the biometric device to the authentication registration server to two-factor authentication (2FA);
confirming that the user and the biometric device have roaming authentication;
sending a message to the solution specific main registration client on the computing device with a code;
starting the solution specific application on the mobile device and entering the code received from the authentication registration server received by the computing device, which was received from the authentication registration server;
send the mobile device sending a RESTful message from the mobile device to the solution specific main registration client on the computing device;
determining if the code sent by mobile application matches the code received from the authentication registration server;
generating an encrypted user assertion on the mobile device by prompting the user to unlock a secure container on the mobile device by with a second authentication factor;
sending the encrypted user assertion from the mobile device to the computing device and relaying the encrypted user assertion from the computing device to the authentication server; and
processing the encrypted user assertion on the authentication server to provide the user with 2FA authentication.

9. The method of claim 8, wherein the 2FA authentication is a smartcard certificate.

10. The method of claim 8, wherein the second authentication factor is a fingerprint, personal identification number (PIN), or password.

11. The method of claim 1, further comprising:
authenticating the user on one or more of the computing devices in which the user and the biometric device has not previously been registered.

12. The method of claim 11, wherein the one or more of the computing devices in which the user and the biometric device has not previously been registered is a multi-function printer, the method further comprising:
sending a print job to the multi-function printer; and
printing the print job on the multi-function printer.

13. The method of claim 1, wherein the biometric device is a wearable biometric device configured to measure electrical activity of a heartbeat of the user.

14. A non-transitory computer readable medium storing computer readable program code executed by a processor for a process for avoidance of user re-registration, the process comprising:
registering a user and a biometric device on a computing device;
sending a registration digital artifact for the user and the biometric device to an authentication server;
registering a mobile device configured to support Public Key Infrastructure (PKI) as a roaming authenticator, the mobile device being registered or tied to information related to the user; and
provisioning the user and the mobile device with roaming authentication, the roaming authentication being accessed through the mobile device and configured to provide the user and the mobile device access to computing devices in which the user and the mobile device have not previously been used for authentication.

15. The computer readable medium of claim 14, further comprising:
initiating registration of the roaming authentication for the user and the biometric device by sending a message with a code to the computing device upon receipt of the registration digital artifact for the user and the biometric device on the authentication server;
receiving the message with the code from the authentication server on the computing device; and
registering a roaming Public Key Infrastructure (PKI) credential hosted on the authentication server on the computing device.

16. The computer readable medium of claim 15, wherein the registering of the PKI credential hosted on the authentication server on the computing device comprises:
initiating a solution specific application hosted on the mobile device;
entering the code from the message received by the computing device into the solution specific application;
sending a RESTful message from the mobile client to a main registration client hosted on the computing device;
relaying the RESTful message received from the main registration client hosted on the mobile device to the authentication server; and
starting a registration process for the user and the biometric device on the authentication server.

17. The computer readable medium of claim 16, further comprising:
creating a PKI Credential (challenge) on the authentication server;
sending the created PKI Credential (challenge) to the computing device;
forwarding the created PKI Credential (challenge) from the computing device to the mobile device;
generating a Key Pair and signing the created PKI Credential (challenge) on the mobile device;
sending a Public Key and an attestation Certificate to the computing device in an encrypted message from the mobile device;
relaying the encrypted message from the computing device to the authentication server, wherein the relay encrypted message includes the signed PKI Credential (challenge), the Public Key, and the attestation;
verifying the signed PKI Credential (challenge), the Public key, and the attestation on the authentication server; and
linking the Public Key as a roaming PKI Credential in a plurality of biometric registration database entries.

18. A system for avoidance of user re-registration, the system comprising:
an authentication server having a processor configured to:
register a user and a biometric device;
registering a mobile device configured to support Public Key Infrastructure (PKI) as a roaming authenticator, the mobile device being registered or tied to information related to the user; and
provision the user and the mobile device with roaming authentication, the roaming authentication being accessed through the mobile device and configured to provide the user and the mobile device access to computing devices in which the user and the mobile device have not previously been used for authentication.

19. The system of claim 18, further comprising:
the biometric device, the biometric device being a wearable biometric device configured to measure electrical activity of a heartbeat of the user, and wherein the mobile device has a roaming PKI Credential, which links the mobile device in a plurality of biometric registration databases for roaming authentication of the user and biometric device.

20. The system of claim 19, wherein the user has a two-factor authentication (2FA), the two-factor authentication being the biometric device as a first authenticator, and a second authenticator, which is received by the mobile device.
